(19) United States
(12) Patent Application Publication
(10) Pub. No.: US 2020/0206998 A1
(43) Pub. Date: Jul. 2, 2020

(54) QUALITY PREDICTION SYSTEM AND MOLDING MACHINE

(71) Applicant: JTEKT Corporation, Osaka-shi (JP)

(72) Inventors: Masaharu HASUIKE, Kariya-shi (JP); Yusuke OKUBO, Kariya-shi (JP); Toshiyuki BABA, Kashihara-shi (JP); Kouji KIMURA, Shiki-gun (JP)

(73) Assignee: JTEKT Corporation, Osaka-shi (JP)

(21) Appl. No.: 16/724,770

(22) Filed: Dec. 23, 2019

(30) Foreign Application Priority Data
Dec. 28, 2018 (JP) 2018-247358
Mar. 7, 2019 (JP) 2019-041736
Jun. 27, 2019 (JP) 2019-119336

(51) Int. Cl. B29C 45/76; B29C 45/77; B29C 45/78; G06N 20/00; G05B 13/02

(52) U.S. Cl. CPC B29C 45/768; B29C 45/77; B29C 45/78; B29C 2945/76277; G05B 13/0265; B29C 2945/7604; B29C 2945/76006; G06N 20/00

(57) ABSTRACT

To provide a quality prediction system predicting a quality element of a molded item using machine learning. The quality prediction system includes a sensor disposed in the mold and configured to detect state data regarding the molten material supplied in the cavity, a learned-model storage unit configured to store a model which is a learned model generated by machine learning in which the state data detected by at least the sensor is used as a training data set and is a learned model related to the state data and a quality element of the molded item, and a quality prediction unit configured to predict the quality element of the molded item which is newly molded based on the state data newly detected by the sensor and the learned model.

### CROSS REFERENCE TO RELATED APPLICATIONS

This application claims priority based on Japanese Patent Application No. 2018-247358 filed on Dec. 28, 2018, Japanese Patent Application No. 2019-041736 filed on Mar. 7, 2019, and Japanese Patent Application No. 2019-119336 filed on Jun. 27, 2019, the entire contents of which are incorporated by reference herein.

### BACKGROUND OF THE INVENTION

### Technical Field

The present invention relates to a quality prediction system and a molding machine.

### Background Art

Technologies for supplying materials heated and melted in molds of molding machines (molten materials) and forming molded items are known. Molten materials are kept in pressure and cooled to be solidified in states in which the molten materials are filled in cavities of molds, and are formed in shapes in accordance with the shapes of the cavities. Here, until the pressure-keeping ends and the molten materials are solidified, the volumes of resin materials are contracted. At this time, the molten materials are not necessarily limited to uniform contractions of the entire materials, and a plenty of knowledge or experience is necessary in order to predict qualities of molded items.

On the other hand, JP2008-207440A discloses a technology for predicting a quality of a molded item which has been injected and molded based on a flow analysis result obtained by simulating a course in which a resin material injected from a gate flows in a mold and is subsequently cooled and solidified. JP2007-83802A discloses a technology for predicting a volume contraction rate of a molded item which has been injected and molded.

### SUMMARY OF THE INVENTION

With regard to the technologies disclosed in JP2008-207440A and JP2007-83802A described above, the inventors have found that a quality element of a molded item can be predicted by ascertaining a measured value of a sensor disposed in a mold for forming a cavity supplied with a molten material and prediction precision of the quality element of the molded item can be improved by using machine learning.

An objective of the present invention is to provide a quality prediction system predicting a quality element of a molded item using machine learning and a molding machine used for the quality prediction system.

### (1. First Quality Prediction System)

A first quality prediction system is applied to a molding method of molding a molded item by supplying a molten material to a cavity of a mold of a molding machine. The quality prediction system includes a first pressure sensor disposed in the mold and configured to detect a pressure received from the molten material supplied in the cavity, a learned-model storage unit configured to store a model which is a learned model generated by machine learning in which the pressure data detected by at least the first pressure sensor is used as a training data set and is a learned model related to the pressure data and the quality element, and a quality prediction unit configured to predict the quality element of the molded item which is newly molded based on the pressure data newly detected by the first pressure sensor and the learned model.

In the first quality prediction system, the first pressure sensor detecting a pressure received from the molten material supplied in the cavity is disposed in the mold of the molding machine. The learned-model storage unit stores a model which is a learned model generated by machine learning in which pressure data detected by at least the first pressure sensor is used as a training data set and is a learned model related to the pressure data and the quality element. The quality prediction unit predicts the quality element of the molded item which is newly molded based on the learned model and the pressure data obtained when a new molded item is molded by the first pressure sensor. Accordingly, the quality prediction system can predict the quality element of the molded item with high precision.

### (2. Second Quality Prediction System)

A second quality prediction system is applied to a molding method of molding a molded item by supplying a molten material to a cavity of a mold of a molding machine. The second quality prediction system includes a first pressure sensor disposed in the mold and configured to detect a pressure received from the molten material supplied in the cavity and a learned-model generation unit configured to generate a learned model related to pressure data detected by at least the first pressure sensor and a quality element of the molded item by machine learning in which the pressure data is used as a training data set. Accordingly, it is possible to predict the quality element of the molded item with high precision as in the first quality prediction system.

### (3. Molding Machine)

A molding machine used for the first quality prediction system includes an operation instruction unit configured to give operation instruction data to a control device of the molding machine, and an operation instruction data adjustment unit configured to adjust the operation instruction data based on a prediction result of the quality element by the quality prediction unit. In the molding machine, the operation instruction unit gives the operation instruction data adjusted by the operation instruction data adjustment unit to the control device. Accordingly, the molding machine can improve the quality of a molded item to be molded.

### BRIEF DESCRIPTION OF DRAWINGS

FIG. 1 is a diagram illustrating a configuration of a quality prediction system of a first example;

FIG. 2 is a diagram illustrating a configuration of a quality prediction system of a second example;

FIG. 3 is a diagram illustrating a molding machine (an injection molding machine);

FIG. 4 is an expanded diagram illustrating a mold illustrated in FIG. 3;

FIG. 5 is a sectional view illustrating the mold taken along the line V-V of FIG. 4;

FIG. 6 is a block diagram illustrating a quality prediction system;

FIG. 7A is a graph illustrating kept-pressure decrease transition data of a molded item formed under a molding condition X;

FIG. 7B is a graph illustrating kept-pressure decrease transition data of a molded item formed under a molding condition Y;

FIG. 8 is a block diagram illustrating a shape prediction system serving as the quality prediction system of the first example;

FIG. 9 is a diagram illustrating a training data set used by a model generation unit for which learning is finished by the shape prediction system serving as the quality prediction system of the first example;

FIG. 10 is a graph illustrating pressure-keeping process transition data of a molded item;

FIG. 11 is a block diagram illustrating a mass prediction system serving as the quality prediction system of the second example;

FIG. 12 is a diagram illustrating a training data set used by a model generation unit for which learning is finished by the mass prediction system serving as the quality prediction system of the second example;

FIG. 13 is a diagram illustrating a relation between a void volume and mass;

FIG. 14 is a block diagram illustrating a void volume prediction system serving as a quality prediction system of a third example;

FIG. 15 is a diagram illustrating a training data set used by a model generation unit for which learning is finished by the void volume prediction system serving as the quality prediction system of the third example;

FIG. 16 is a sectional view illustrating a mold of the second example taken along the line V-V of FIG. 4;

FIG. 17 is a block diagram illustrating a quality prediction system of a fourth example; and

FIG. 18 is a graph illustrating a transition of material temperature data.

### DESCRIPTION OF THE EMBODIMENTS

### (1. Application Target of Quality Prediction System)

A quality prediction system is applied to a molding method of molding a molded item by supplying a molten material to a cavity of a mold of a molding machine. In this example, a case in which a molding machine is an injection molding machine performing injection molding of a resin, rubber, or the like will be described as an example. However, the molding machine 1 may be a molding machine other than an injection molding machine, for example, a blow molding machine or a compression molding machine or may be a casting machine performing metal casting, such as a die cast.

### (2. Configurations of Quality Prediction Systems 100 and 200)

The quality prediction systems 100 and 200 include a single molding machine 1 or a plurality of molding machines 1 and machine learning devices 110 and 210. The machine learning device 110 generates a learned model related to molding data detected in at least the molding machine 1 and a quality element of the molded item by performing machine learning using the molding data as a training data set. Then, the machine learning devices 110 and 210 predict a quality element of a molded item which is newly molded based on the learned model and the new molding data.

### (2-1. Configuration of Quality Prediction System 100 of First Example)

A configuration of the quality prediction system 100 of a first example will be described with reference to FIG. 1. As illustrated in FIG. 1, the quality prediction system 100 of the first example includes a plurality of molding machines 1 and a machine learning device 110. The machine learning device 110 includes a first server 111 and a second server 112. Here, the first server 111 and the second server 112 are assumed to be separate devices in the description, but may be configured as the same device. As the machine learning device 110, a device that has no server function can also be used. That is, the machine learning device 110 may be an arithmetic processing device that includes at least a processor and a memory. In this example, each of the first server 111 and the second server 112 includes at least a processor and a memory.

The first server 111 functions as a learning phase in machine learning. The first server ill generates a learned model by machine learning in which the acquired training data set is used. The first server 111 is provided to be able to communicate with the plurality of molding machines 1 and acquires molding data obtained when each of the plurality of molding machines 1 molds a molded item, as a part of the training data set. The molding data includes, for example, pressure data, temperature data, and data regarding a molding condition. The pressure data is data indicating a pressure at which a mold is received from a molten material supplied to a mold. The temperature data is data indicating a temperature of the molten material supplied to the mold.

The first server 111 further acquires data related to a quality element of the molded item molded by each of the plurality of molding machines 1 (hereinafter referred to as “quality element data”) as supervised data in the training data set. Then, the first server 111 generates a learned model related to the molding data and the quality element of the molded item by performing the supervised learning. A case in which the machine learning in the first server 111 is supervised learning will be described as an example, but another machine learning algorithm can also be applied.

The first server 111 may acquire data when a worker inputs the quality element data measured by a measurement instrument (not illustrated). The first server 111 may directly acquire the quality element data measured by a measurement instrument from the measurement instrument. The quality element data is data associated with a corresponding molded item. As the quality element data, for example, various dimensions, mass, a void volume, and the degree of burning, and the like of a molded item can be exemplified.

In this way, in the quality prediction system 100, the first server ill can acquire large quantities of molding data and quality element data since the first server 111 can acquire the molding data and the quality element data obtained when each of the plurality of molding machines 1 molds a molded item. Then, the first server ill generates a learned model by machine learning in which the acquired large quantities of molding data and quality element data are used as a training data set. Accordingly, it is possible to improve learning precision of the learned model and it is possible to achieve high precision of the learned model.

The second server 112 functions as a reasoning phase in the machine learning. The second server 112 acquires the learned model generated by the first server 111. Further, the second server 112 is provided to be able to communicate with each of the plurality of molding machines 1. The second server 112 predicts a quality element of a molded item which is newly molded by using the learned model generated by the first server 111 and by using, as input data, molding data when each of the plurality of molding machines 1 newly molds the molded item.

The quality element of the molded item predicted by the second server 112 may be transmitted to the molding machine 1 and may be used to adjust a molding condition of the molding machine 1. When it is determined that the predicted quality element of the molded item is bad, the molding machine 1 may perform a disposal process or a selection process for the molded item.

### (2-2. Configuration of Quality Prediction System 200 of Second Example)

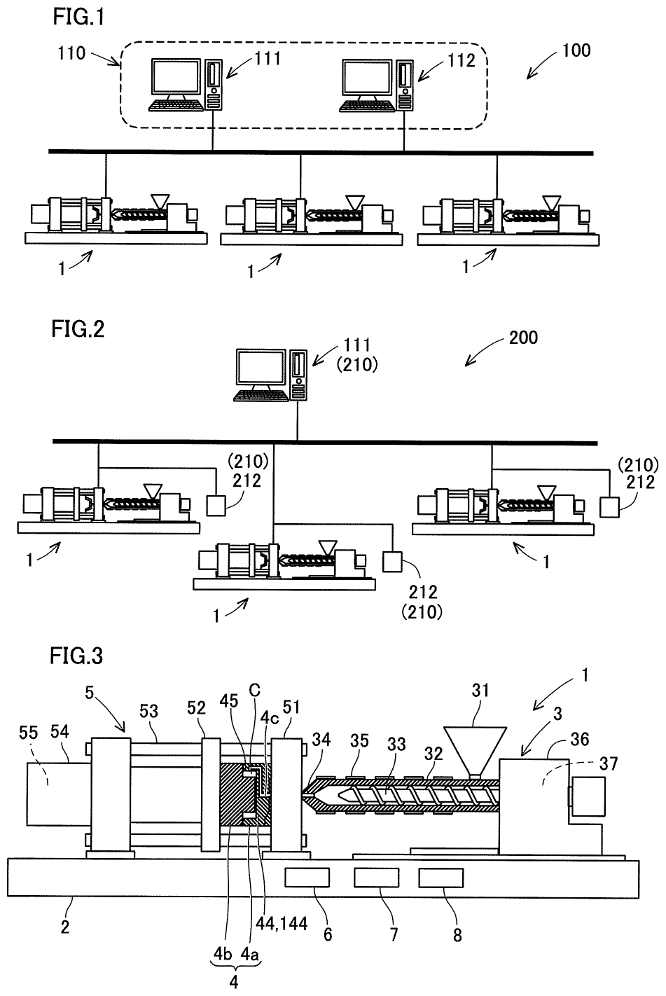

A configuration of the quality prediction system 200 of the second example will be described with reference to FIG. 2. As illustrated in FIG. 2, the quality prediction system 200 of the second example includes a plurality of molding machines 1 and a machine learning device 210. The machine learning device 210 includes a first server 111 and a plurality of quality prediction devices 212. The machine learning device 210 can also use a device that does not have a server function. The machine learning device 210 may be an arithmetic processing device that includes at least a processor and a memory. In this example, each of the first server 111 and the quality prediction devices 212 includes at least a processor and a memory.

The first server 111 has the same configuration as the first server 111 of the first example. The plurality of quality prediction devices 212 are disposed to correspond to the plurality of molding machines 1, respectively, and function as so-called edge computers. Each of the quality prediction devices 212 performs substantially the same process as the second server 112 in the quality prediction system 100 of the first example. That is, the quality prediction device 212 predicts a quality element of a molded item molded by the corresponding molding machine 1 based on molding data by the corresponding molding machine 1 and a learned model generated by the first server 111.

### (2-3. Configuration of Quality Prediction System of Third Example)

The configurations of the quality prediction systems 100 and 200 including the plurality of molding machines 1 have been described. Additionally, a quality prediction system may include a single molding machine 1 and a machine learning device. The machine learning device can perform a learning phase of machine learning equivalent to the first server 111 and can perform a reasoning phase of machine learning equivalent to the second server 112 or the quality prediction device 212. In this case, the machine learning device may be an arithmetic processing device that includes at least a processor and a memory.

### (3. Example of Molding Machine 1)

### (3-1. Configuration of Molding Machine 1)

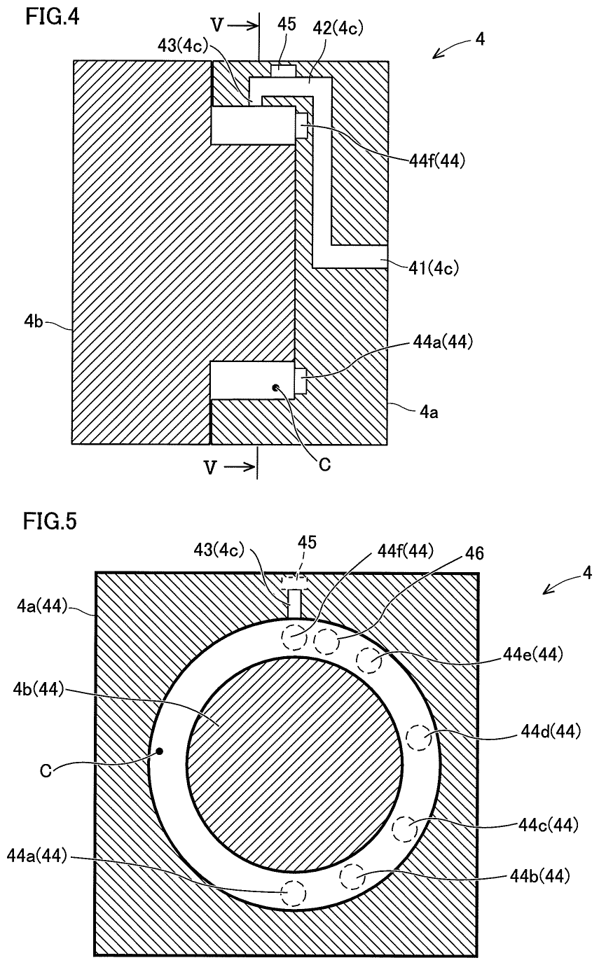

Next, an injection molding machine which is an example of the molding machine 1 will be described with reference to FIG. 3. The molding machine 1 serving as an injection molding machine mainly includes a bed 2, an injection device 3, a mold 4, a clamping device 5, an operation instruction unit 6, and a control device 7.

The injection device 3 is disposed on the bed 2. The injection device 3 mainly includes a hopper 31, a heating cylinder 32, a screw 33, a nozzle 34, a heater 35, a driving device 36, and an injection device sensor 37.

The hopper 31 is an input port of a pellet (granular molding material). The heating cylinder 32 pressurizes a molten material obtained by heating and melting the pellet input into the hopper 31. The heating cylinder 32 is provided to be able to move in an axial direction with respect to the bed 2. The screw 33 is disposed inside the heating cylinder 32 and is provided to be rotatable or movable in the axial direction. The nozzle 34 is an exit port provided at a front end of the heating cylinder 32 and is moved in the axial direction of the screw 33 to supply the molten material inside the heating cylinder 32 to the mold 4.

For example, the heater 35 is provided outside of the heating cylinder 32 and heats the pellet inside the heating cylinder 32. The driving device 36 performs movement of the heating cylinder 32 in the axial direction, rotation of the screw 33 and movement in the axial direction, and the like. The injection device sensor 37 is a generic term of a sensor acquiring a storage amount, a pressure-keeping force, a pressure-keeping time, and an injection speed of the molten material, a viscosity of the molten material, a state of the driving device 36, and the like. Here, the injection device sensor 37 is not limited thereto and various kinds of information may be acquired.

The mold 4 is a die including a first mold 4a which is the fixing side and a second mold 4b which is a movable side. In the mold 4, a cavity C is formed between the first mold 4a and the second mold 4b when the first mold 4a and the second mold 4b are clamped. The first mold 4a includes a supply passage 4c (a sprue, a runner, and a gate) guiding the molten material supplied from the nozzle 34 to the cavity C.

Further, sensors are disposed in the first mold 4a or the second mold 4b. That is, the sensors can detect state data measurable in the first mold 4a and the second mold 4b. Examples of the sensors are, for example, pressure sensors 44 and 45. The pressure sensors 44 and 45 detect a pressure received from the molten material. Another example of the sensor is a material temperature sensor 144. The material temperature sensor 144 detects a temperature of the molten material supplied to the mold 4. In the mold 4, the pressure sensors 44 and 45 and the material temperature sensor 144 may be disposed, only the pressure sensors 44 and 45 may be disposed, or only the material temperature sensor 144 may be disposed.

The clamping device 5 is disposed on the bed 2 to face the injection device 3. The clamping device 5 performs an operation of switching the mounted mold 4 and causes the mold 4 not to be opened due to the pressure of the molten material injected to the cavity C in a fasten state of the mold 4.

The clamping device 5 includes a fixed platen 51, a movable platen 52, a tie-bar 53, a driving device 54, and a clamping device sensor 55. The first mold 4a is fixed to the fixed platen 51. The fixed platen 51 can come into contact with the nozzle 34 of the injection device 3 and guides the molten material injected from the nozzle 34 to the mold 4. The second mold 4b is fixed to the movable platen 52. The movable platen 52 can approach the fixed platen 51 or can be separated from the fixed platen 51. The tie-bar 53 supports the movement of the movable platen 52. The driving device 54 is configured by, for example, a cylinder device and moves the movable platen 52. The clamping device sensor 55 is a generic term of a sensor acquiring a clamping force, a die temperature, a state of the driving device 54, and the like.

The operation instruction unit 6 gives operation instruction data regarding a molding condition to the control device 7. The molding machine 1 includes an operation instruction data adjustment unit 8 adjusting the operation instruction data stored in the operation instruction unit 6 based on a prediction result of a quality element by the second server 112 or the quality prediction device 212. Since the operation instruction unit 6 gives the operation instruction data adjusted by the operation instruction data adjustment unit 8 to the control device 7, the molding machine 1 can improve the quality of a molded item to be molded.

The control device 7 controls the driving device 36 of the injection device 3 and the driving device 54 of the clamping device 5 based on the operation instruction data from the operation instruction unit 6. For example, the control device 7 acquires various kinds of information from the injection device sensor 37 and the clamping device sensor 55 and controls the driving device 36 of the injection device 3 and the driving device 54 of the clamping device 5 such that an operation is performed in accordance with the operation instruction data.

### (3-2. Method of Molding Molded Item by Molding Machine 1)

Next, a method of causing the molding machine 1 serving as an injection molding machine to mold a molded item will be described. In the molding method by the molding machine 1, a measuring step, a clamping step, an injection filling step, a pressure-keeping step, a cooling step, and a release extracting step are sequentially performed. In the measuring step, while the pellet is melted by shear frictional heat caused by heating of the heater 35 and rotation of the screw 33, the molten material is stored between the front end of the heating cylinder 32 and the nozzle 34. With an increase in the storage amount of the molten material, the screw 33 is retreated, the storage of the molten material is measured from a retreated position of the screw 33.

In the clamping step subsequent to the measuring step, the first mold 4a and the second mold 4b are matched to be clamped by moving the movable platen 52. Further, the heating cylinder 32 is moved in the axial direction and approaches the clamping device 5 to connect the nozzle 34 to the fixed platen 51 of the clamping device 5. Subsequently, in the injection filling step, by moving the screw 33 toward the nozzle 34 by a predetermined pushing force in a state in which the rotation of the screw 33 stops, the molten material is injected to the mold 4 at a high pressure so that the mold 4 is filled with the molten material. At this time, since a temperature of the molten material supplied to the mold 4 increases due to shear heating, the temperature of the molten material becomes higher than the temperature of the heated mold 4.

When the cavity C is filled with the molten material, the step continuously proceeds to a pressure-keeping step. In the pressure-keeping step, a pressure-keeping process of further pushing the molten material into the cavity C in the state in which the cavity C is filled with the molten material and applying a predetermined pressure (pressure-keeping force) to the molten material in the cavity C for a predetermined time is performed. Specifically, by applying a constant pushing force to the screw 33, a predetermined pressure-keeping force is applied to the molten material. In the pressure-keeping step, the temperature of the molten material supplied to the mold 4 gradually decreases.

Then, after the pressure-keeping process is performed by the predetermined pressure-keeping force for the predetermined time, the step proceeds to the cooling step. In the cooling step, a process of stopping pushing the molten material and decreasing the pressure-keeping force (a pressure-keeping force decreasing process) is performed and the mold 4 is cooled. By cooling the mold 4, the molten material supplied to the mold 4 is solidified. In the cooling step, since the mold 4 is maintained in the continuously heated state, the temperature of the molten material decreases to the temperature of the mold 4 over time. Before the temperature of the molten material decreases to the temperature of the mold 4, the cooling step can also end. Finally, in the release extraction step, the second mold 4b is separated from the first mold 4a to extract the molded item. Here, since the molten material supplied to the mold 4 is exposed to the ambient air at the time of opening the mold, the temperature of the molten material suddenly decreases to the ambient temperature.

### (4. Detailed Configuration of Mold 4 of First Example)

Here, a detailed configuration of the mold 4 of a first example will be described with reference to FIGS. 4 and 5. The mold 4 is a so-called multi-piece die. In the mold 4, a plurality of cavities C are formed. However, to simplify the drawing, only one cavity C is illustrated in FIGS. 4 and 5. In the embodiment, a molded item molded by the molding machine 1 is a retainer used for, for example, a constant velocity joint. Accordingly, a molded item is annular, in particular, toric. The cavity C is formed in an annular shape copying the shape of the retainer, in particular, the toric shape. The shape of a molded item and the cavity C may have a shape other than an annular shape and may have, for example, a C shape, a rectangular frame shape, or the like.

The supply passage 4c includes a sprue 41, a runner 42, and a gate 43. The sprue 41 is a passage to which the molten material is supplied from the nozzle 34. The runner 42 is a passage branching from the sprue 41 and the molten material supplied to the sprue 41 flows in the runner 42. The gate 43 is a passage guiding the molten material flowing in the runner 42 to the cavity C and a passage cross-sectional area of the gate 43 is smaller than a passage cross-sectional area of the runner 42. The same numbers of runners 42 and gates 43 as the number of cavities C are formed in the mold 4. The molten material supplied to the sprue 41 is supplied to each cavity C via the runner 42 and the gate 43.

When the cavity C is annular and the first mold 4a includes one gate 43, an inflow path of the molten material in the cavity C is a path along which the material flows in the annular circumferential direction of the cavity C from the gate 43. That is, in the cavity C, the molten material first flows to the vicinity of the gate 43, and then branches and moves in two directions after the molten material flows in the cavity C from the gate 43. Finally, the molten material flows at a position farthest from the gate 43 (hereinafter referred to as a “farthest position”). That is, the molten material joins near the farthest position.

### (5. Pressure Sensors 44 and 45)

Next, the pressure sensors 44 and 45 disposed in the mold 4 will be described with reference to FIGS. 4 and 5. In the mold 4, the first pressure sensor 44 detecting a pressure received from the supplied molten material is provided in the cavity C. The first pressure sensor 44 is provided one or both of the first mold 4a and the second mold 4b. The first pressure sensor 44 may be a contact sensor or a contactless sensor.

Specifically, the mold 4 includes six first pressure sensors 44a to 44f. The six first pressure sensors 44a to 44f are all provided in the first mold 4a. The six first pressure sensors 44a to 44f are disposed at a plurality of positions at which distances from the gate 43 are different and detect pressures received from the molten material at the positions at which the pressure sensors 44a to 44f are disposed. Some (the first pressure sensors 44a to 44c) of the six first pressure sensors 44a to 44f are disposed at intermediate positions in the inflow path to be closer to the farthest position from the gate 43 than the gate 43. On the other hand, the other pressure sensors (the first pressure sensors 44d to 44f) of the six first pressure sensors 44a to 44f are disposed at positions closer to the gate 43 than the farthest position from the gate 43 at the intermediate positions in the inflow path.

Of the six first pressure sensors 44a to 44f, the first pressure sensor 44a is disposed at a position most away from the gate 43 in the inflow path. The first pressure sensor 44b is disposed at a position next most away from the gate 43 and the first pressure sensors 44c to 44e are sequentially disposed at positions away from the gate 43. In addition, the first pressure sensor 44f is disposed at a position closest from the gate 43.

Specifically, the first pressure sensor 44a is disposed in a region at which the molten material flowing in the cavity C from the gate 43 arrives finally. On the other hand, the first pressure sensor 44f is disposed in a region which is a region on an extension line of the gate 43 and is a region in which the molten material first flows in the cavity C.

Further, in the mold 4, the second pressure sensor 45 detecting a pressure received from the molten material is provided in the supply passage 4c. At least one second pressure sensor 45 is disposed in one of the first mold 4a and the second mold 4b. The second pressure sensor 45 may be a contact sensor or a contactless sensor. Specifically, the mold 4 includes one second pressure sensor 45. The second pressure sensor 45 is disposed in the first mold 4a and detects a pressure received from the molten material in the runner 42.

The mold 4 may further include a temperature sensor 46. The temperature sensor 46 is provided in, for example, the first mold 4a as in the first pressure sensors 44a to 44f. The temperature sensor 46 detects a temperature of the molten material inside the mold 4. Here, the temperature sensor 46 can indirectly detect the temperature of the molten material by detecting a temperature of a predetermined position of the mold 4. In the mold 4, the plurality of temperature sensors 46 may be disposed as in the plurality of first pressure sensors 44a to 44f. That is, the plurality of temperature sensors 46 are disposed at a plurality of positions at which distances from the gate 43 are different.

### (6. Configurations of Machine Learning Device 110 or 210)

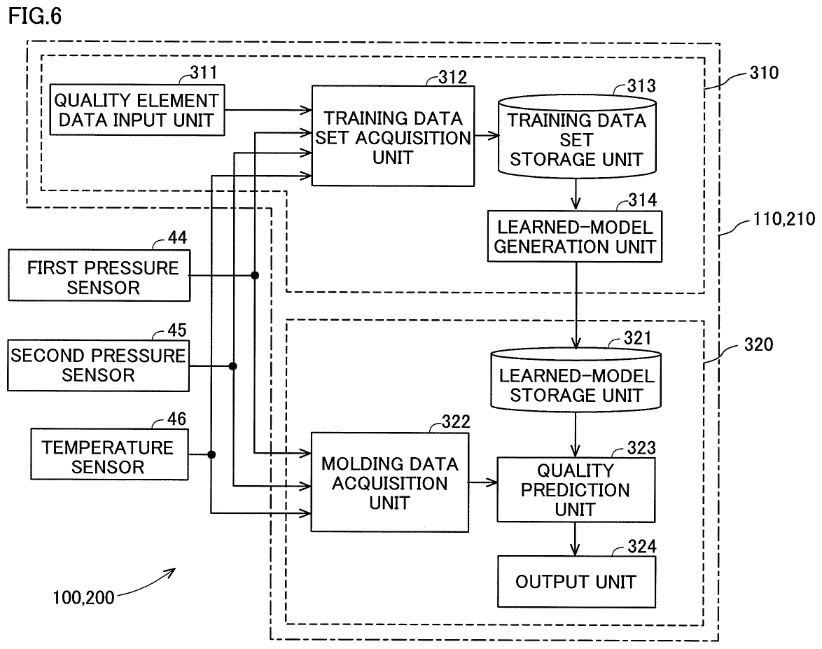

Next, a configuration of the machine learning device 110 or 210 (illustrated in FIGS. 1 and 2) will be described with reference to FIG. 6. As illustrated in FIG. 6, the machine learning device 110 or 210 includes a learning processing device 310 capable of performing a learning phase and a quality prediction device 320 capable of performing a reasoning phase. Here, the learning processing device 310 is equivalent to the first server 111 in the above-described quality prediction system 100 or 200. The quality prediction device 320 is equivalent to a second server 112 in the above-described quality prediction system 100 of the first example and is equivalent to the quality prediction device 212 in the quality prediction system 200 of the second example.

The learning processing device 310 includes a quality element data input unit 311, a training data set acquisition unit 312, a training data set storage unit 313, and a learned-model generation unit 314. The quality element data input unit 311 inputs quality element data associated to a corresponding molded item. As the quality element data, for example, a shape (various dimensions), mass, a void volume, the degree of burning, and the like of a molded item can be exemplified.

The training data set acquisition unit 312 acquires the molding data such as pressure data or temperature data and the quality element data input to the quality element data input unit 311 as a training data set from the molding machine 1. The acquired training data set is stored in the training data set storage unit 313. The learned-model generation unit 314 generates a learned model related to the molding data and the quality element of the molded item by performing machine learning in which the associated molding data and quality element data are used as a training data set based on the molding data (pressure data or temperature data) and the quality element data stored in the training data set storage unit 313.

The quality prediction device 320 mainly includes a learned-model storage unit 321, a molding data acquisition unit 322, a quality prediction unit 323, and an output unit 324. The learned-model storage unit 321 stores the learned model generated by the learned-model generation unit 314. When the molding machine 1 newly molds a molded item, the molding data acquisition unit 322 acquires the molding data detected by the first pressure sensor 44, the second pressure sensor 45, the temperature sensor 46, and the like.

In this example, the molding data acquisition unit 322 acquires all of the pressure data detected by the six first pressure sensors 44 and the second pressure sensor 45, but the present invention is not limited thereto. That is, the molding data acquisition unit 322 may acquire only some of the pressure data detected by the six first pressure sensors 44 and the second pressure sensor 45. That is, the molding data acquisition unit 322 can select and acquire only the pressure data necessary for quality prediction by the quality prediction device 320.

The quality prediction unit 323 predicts a quality element of the molded item which is newly molded based on the molding data acquired by the molding data acquisition unit 322 and the learned model stored in the learned-model storage unit 321. The quality element predicted by the quality prediction unit 323 is included in the quality element input as the quality element data to the quality element data input unit 311. As the quality element predicted by the quality prediction unit 323, for example, a shape (various dimensions), mass, a void volume, the degree of burning, and the like of a molded item can be exemplified.

The quality prediction unit 323 can perform quality determination on the molded item based on the predicted quality element and a preset allowable value. In this case, the quality prediction unit 323 may perform quality determination on the molded item after the molded item is molded by the molding machine 1 and before a subsequent step of the molding step by the molding machine 1 is performed.

The output unit 324 outputs a prediction result by the quality prediction unit 323. For example, the output unit 324 performs guidance through display guidance by a display device (not illustrated), guidance through a sound, guidance through display lamp, or the like. In this case, the output unit 324 may perform guidance by a display device or the like provided in the quality prediction device 320 or may perform guidance by a display device or the like provided in each of the plurality of molding machines 1. The output unit 324 may perform guidance by a display device or the like provided in a management device. The output unit 324 can also perform guidance by a portable terminal owned by a worker or a manager.

Further, when the quality prediction unit 323 performs the quality determination, the output unit 324 can also output a quality determination result to the molding machine 1 and cause the molding machine 1 to perform a process in accordance with the quality determination result. For example, when the molded item is determined to be bad in the quality determination result of the quality element of the molded item, the output unit 324 may cause the molding machine 1 to perform a disposal process or a selection process for the molded item.

In this example, the quality element of the molded item is predicted using the learned model generated using the pressure data detected by the first pressure sensor 44 and the second pressure sensor 45, the temperature data detected by the temperature sensor 46, and the like as the data obtained in the molding of the molded item by the molding machine 1, but the present invention is not limited thereto. That is, the quality element of the molded item may be predicted using a learned model generated without using the temperature data.

In this way, in the learning processing device 310, the learned-model generation unit 314 generates a learned model related to at least the pressure data and the quality element of the molded item by machine learning in which at least the pressure data and the quality element data are used as a training data set. In the quality prediction device 320, the learned-model storage unit 321 stores the learned model generated by the learned-model generation unit 314. Then, the quality prediction unit 323 predicts a quality element of the molded item which is newly molded based on the pressure data obtained at the time of molding the new molded item and the learned model stored in the learned-model storage unit 321. Accordingly, the machine learning device 110 or 210 can predict the quality element of the molded item with high precision. Hereinafter, a method of predicting various quality elements using the machine learning device 110 or 210 will be described giving a specific example.

### (7. Quality Prediction Systems 100 and 200 of First Example)

Next, a shape prediction system 100a which is a first example of the quality prediction system 100 or 200 will be described. The shape prediction system 100a is a quality prediction system that predicts shape precision of a molded item molded by the molding machine 1. Here, a case in which the shape prediction system 100a predicts roundness of an outer circumferential surface or an inner circumferential surface of a molded item molded in an annular shape among the dimensions of the molded item will be described as an example.

### (7-1. Pressure Data in Shape Prediction System 100a)

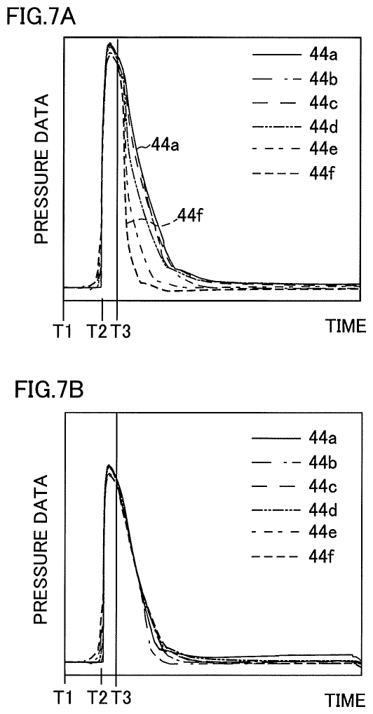

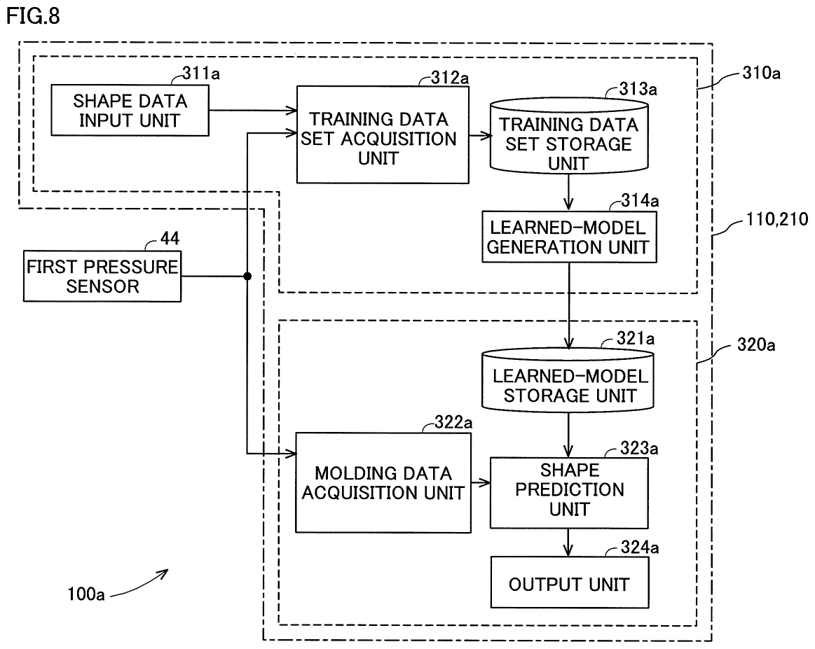

Pressure data detected by the six first pressure sensors 44a to 44f from the injection filling step via the pressure-keeping step to the cooling step will be described with reference to FIGS. 7A and 7B. FIG. 7A illustrates a graph indicating pressure transition data in molding of a molded item molded under a predetermined molding condition X from the injection filling step to the cooling step. FIG. 7B illustrates a graph indicating pressure transition data in molding of a molded item molded under a molding condition Y different from the molding condition X from the injection filling step to the cooling step.

The roundness of the molded item molded under the molding condition X is larger than the roundness of the molded item molded under the molding condition Y. That is, the molded item molded under the molding condition X is lower in shape precision than the molded item molded under the molding condition Y. Hereinafter, a relation between the pressure transition data and the shape precision will be described.

In FIGS. 7A and 7B, a step between T1 to T2 is the injection filling step, a step between T2 to T3 is the pressure-keeping step, and a step after T3 is the cooling step. A starting time of the pressure-keeping process is a time at which the pressure data of all the first pressure sensors 44 becomes a value which is not zero (a value larger than a predetermined minute value) since the cavity C is filled at the starting time. An ending time of the pressure-keeping process, that is, a starting time of the pressure-keeping force decreasing process, is a time at which the applying of a pushing force by the screw 33 stops. Hereinafter, the pressure transition data in the pressure-keeping process is referred to as “pressure-keeping process transition data” and the pressure transition data in the pressure-keeping force decreasing process is referred to as “decreasing process transition data.”

When the pressure-keeping force decreasing process starts, it is considered that the shape precision of the molded item after solidification is improved by uniformly contracting the molten material in the cavity C in the entire region. When the molten material with which the cavity C is filled uniformly contracts in the entire region after the pressure-keeping force decreasing process starts, the decreasing process transition data of the six first pressure sensors 44 are considered to be approximate. On the other hand, when the degree of contraction of the molten material is considerably different depending on a position of the molten material in the cavity C after the pressure-keeping force decreasing process starts, a variation in the decreasing process transition data of the six first pressure sensors 44 is considered to increase.

When the graph illustrated in FIG. 7A is compared with the graph illustrated in FIG. 7B, a variation in a behavior among the respective decreasing process transition data can be determined to be larger in the decreasing process transition data under the molding condition X than in the decreasing process transition data under the molding condition Y. In particular, for the decreasing process transition data of the molding condition X, a difference between a behavior of the decreasing process transition data of the first pressure sensor 44a and a behavior of the decreasing process transition data of the first pressure sensor 44f can be determined to be large.

That is, under the molding condition X, in the molten material with which the cavity C is filled, the degree of contraction of the molded item after the pressure-keeping force decreasing process starts can be determined to vary between the molten material located near the gate 43 and the molten material located away from the gate 43. As a result, it can be determined that the shape precision is lower and the roundness is larger in the molded item molded under the molding condition X than in the molded item molded under the molding condition Y. In this way, a difference or a variation in data of the pressure-keeping force decreasing process of the six first pressure sensors 44a to 44f has high correlation with the shape precision of the molded item.

### (7-2. Configuration of Shape Prediction System 100a)

Next, a configuration of the shape prediction system 100a will be described with reference to FIG. 8. As illustrated in FIG. 8, the shape prediction system 100a includes the plurality of molding machines 1 (illustrated in FIGS. 1 and 2), the learning processing device 310a, and a shape prediction device 320a.

In the shape prediction system 100a, pressure data is pressure data in the mold 4 detected by the pressure sensors 44 and 45 in the pressure-keeping force decreasing process. Hereinafter, the pressure data in the pressure-keeping force decreasing process is defined as “decreasing process pressure data” and a relation between pressure data and a time elapsed after the pressure-keeping force starts to decrease is defined as “decreasing process transition data.”

The learning processing device 310 includes a shape data input unit 311a, a training data set acquisition unit 312a, a training data set storage unit 313a, and a learned-model generation unit 314a. The shape data input unit 311a is an example of the quality element data input unit 311. Then, measured values of the roundness of the outer circumferential surface and the inner circumferential surface of the molded item molded by the molding machine 1 are input as quality element data to the shape data input unit 311a.

The training data set acquisition unit 312a acquires shape data (roundness data) of the molded item input as the quality element data to the shape data input unit 311a. The training data set acquisition unit 312a collects the pressure data detected by the pressure sensors 44 and 45 in the pressure-keeping decreasing process in each of the plurality of molding machines 1 as the decreasing process pressure data. The acquired training data set is stored in the training data set storage unit 313a.

The learned-model generation unit 314a generates a learned model related to the decreasing process pressure data and the shape (roundness) of the molded item by performing machine learning in which the associated decreasing process pressure data and the shape data are used as a training data set based on the decreasing process pressure data and the shape data stored in the training data set storage unit 313a.

The shape prediction device 320a is an example of the quality prediction device 320. The shape prediction device 320a includes a learned-model storage unit 321a, a molding data acquisition unit 322a, a shape prediction unit 323a, and an output unit 324a. The learned-model storage unit 321a stores the learned model generated by the learned-model generation unit 314a. The molding data acquisition unit 322a acquires the pressure data detected by the six first pressure sensors 44a to 44f as the decreasing process pressure data when the molding machine 1 newly molds a molded item. The shape prediction unit 323a which is an example of the quality prediction unit 323 predicts a shape (roundness) of the molded item which is newly molded based on the decreasing process pressure data (the decreasing process transition data) acquired by the molding data acquisition unit 322a and the learned model stored in the learned-model storage unit 321a.

Here, in the shape prediction system 100a of this example, the decreasing process pressure data includes the pressure data detected by the six first pressure sensors 44a to 44f in the pressure-keeping force decreasing process. With regard to this point, the decreasing process pressure data may include pressure data detected by the second pressure sensor 45. The decreasing process pressure data can also be pressure data detected by only some of the six first pressure sensors 44a to 44f.

Specifically, the training data set acquisition unit 312a and the molding data acquisition unit 322a may acquire pressure data from at least two of the six first pressure sensors 44a to 44f as the decreasing process pressure data. Thus, the learned-model generation unit 314a can generate a learned model that has correlation between the difference or the variation in the degree of contraction at the positions of the molten material in the cavity C and the shape precision (the shape data, in particular, the roundness data). Then, the shape prediction unit 323a can improve the prediction precision since the shape (roundness) of the molded item is predicted based on the difference or the variation in the degree of contraction at the positions of the molten material in the cavity C.

The training data set acquisition unit 312a and the molding data acquisition unit 322a preferably acquire the decreasing process pressure data detected by at least one of the first pressure sensors 44d to 44f disposed at the positions closer to the gate 43 than the intermediate positions in the inflow path and the pressure data detected by at least one of the first pressure sensors 44a to 44c disposed at the positions closer to the farthest from the gate 43 than the intermediate positions in the inflow path. Thus, the learned-model generation unit 314a can generate a learned model that has higher correlation between the shape precision and the difference or the variation in the degree of contractions at the positions of the molten material in the cavity C, and thus the shape prediction unit 323a can further improve the prediction precision of the shape (roundness) of the molded item.

Further, in this case, the training data set acquisition unit 312a and the molding data acquisition unit 322a preferably acquire the pressure data from two pressure sensors, the first pressure sensor 44a disposed at the farthest position from the gate 43 and the first pressure sensor 44f disposed at a position closest to the gate 43 among the six first pressure sensors 44a to 44f.

That is, the two first pressure sensors 44a and 44f are disposed at the farthest positions in the inflow path among the six first pressure sensors 44a to 44f. In the molten material with which the cavity C is filled, the degree of contraction after the pressure-keeping force starts to decrease is considered to easily vary in the molten material located in the regions in which the two first pressure sensors 44a and 44f are located. Accordingly, when the pressure data acquired from some of the six first pressure sensors 44a to 44f are set as the decreasing process pressure data, the learned-model generation unit 314a can generate the learned model with high precision by including the pressure data of the two first pressure sensors 44a and 44f. Thus, the shape prediction unit 323a can improve the prediction precision of the shape of the molded item.

In particular, in the mold 4 of the molding machine 1, the gate 43 is provided at one position in one cavity C and the molten material flowing in the cavity C flows in the annular circumferential direction of the cavity C from the gate 43. In this case, by pushing the molten material from the gate 43 to the cavity C, a difference in the pressure applied to the molten material with which the cavity C is filled increases between positions close to and away from the gate 43. Thus, this difference has an effect on the shape precision of the molded item.

With regard to this point, the learned-model generation unit 314a generates the learned model in which the decreasing process pressure data (the decreasing process transition data) detected by the plurality of first pressure sensors 44 disposed at the plurality of positions at which distances from the gate 43 are different is used as the training data set. Then, the shape prediction unit 323a predicts the shape (roundness) of the molded item based on the learned model and the decreasing process pressure data (the decreasing process transition data) detected by the plurality of first pressure sensors 44. Accordingly, the shape prediction system 100a can improve the prediction precision of the shape (roundness) of the molded item.

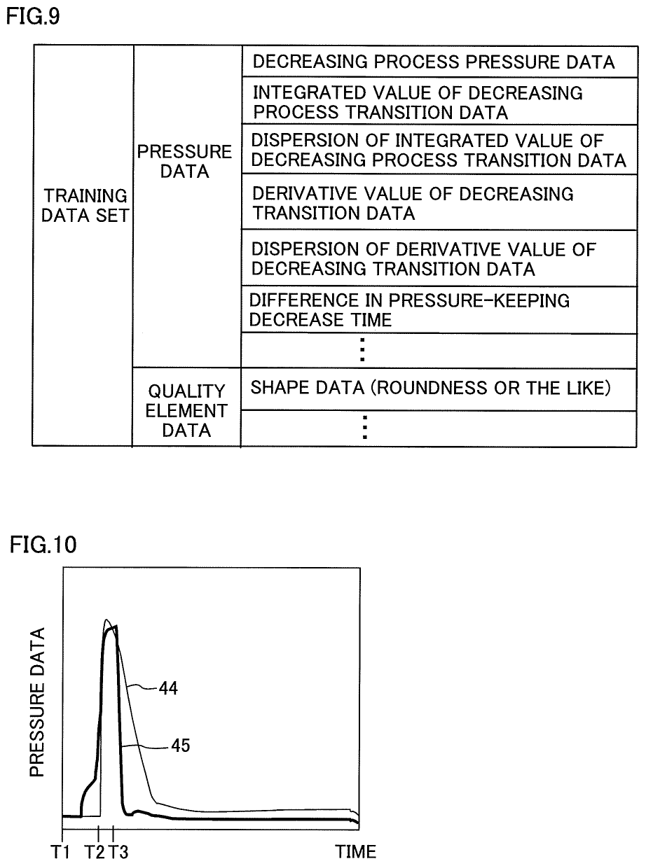

Here, an example of the training data set used when the learned-model generation unit 314a generates the learned model will be described with reference to FIG. 9. The learned-model generation unit 314a can use not only the decreasing process pressure data of the plurality of first pressure sensors 44 but also a statistical amount obtained from the decreasing process transition data as the training data set. The same applies to a case in which the pressure data of the second pressure sensor 45 is acquired as the decreasing process pressure data.

For example, as illustrated in FIG. 9, the training data set includes an integrated value obtained by integrating the decreasing process transition data with respect to time, a derivative value obtained by differentiating the decreasing process transition data with respect to time, and a pressure-keeping decrease time which is a time necessary until the pressure-keeping force starts to decrease and the pressure data becomes equal to or less than a predetermined value close to zero. In this way, the learned-model generation unit 314a can ascertain a statistical amount such as the training data set accurately by using the integrated value, the derivative value, and the pressure-keeping decrease time as the training data set, and therefore it is possible to achieve high precision of the learned model.

The training data set includes a statistical amount indicating a variation in the decreasing process pressure data among the plurality of first pressure sensors 44. As described above, there is the relation in which the roundness of the molded item is larger as the variation in the decreasing process pressure data is larger. Accordingly, the learned-model generation unit 314a can generate the learned model with high correlation between the variation and the shape precision of the molded item, in particular, the roundness by including the statistical amount indicating the variation in the decreasing process pressure data as the training data set.

As examples of the statistical amount indicating the variation in the decreasing process pressure data, a difference in the decreasing process pressure data among the plurality of first pressure sensors 44, a dispersion of the plurality of pieces of decreasing process pressure data, a difference in a temporal integrated value of the plurality of decreasing process transition data, a dispersion of the temporal integrated value of the decreasing process transition data, a difference in a mean value of temporal derivative values of the decreasing process transition data, a dispersion in the mean value of the temporal derivative values of the decreasing process transition data, a difference in a pressure-keeping decrease time between the first pressure sensors 44, and the like are exemplified.

As described above, the learned-model generation unit 314a generates the learned model by performing the machine learning in which the shape data (the roundness data) and six pieces of decreasing process pressure data (the decreasing process transition data) detected by the plurality of first pressure sensors 44 in the decreasing process are used as a training data set. Then, the learned-model storage unit 321a stores the learned model generated by the learned-model generation unit 314a. Further, the shape prediction unit 323a predicts the shape (the roundness) of the molded item which is newly molded based on the decreasing process pressure data (the decreasing process transition data) acquired by the molding data acquisition unit 322a when the molded item is newly molded and the learned model stored in the learned-model storage unit 321a. Accordingly, the shape prediction system 100a can predict the shape of the molded item with high precision.

Further, the plurality of first pressure sensors 44 are disposed at the plurality of different positions in the cavity C. Each of the first pressure sensors 44 detects a pressure received from the molten material at each of the disposed positions in the pressure-keeping force decreasing process. The training data set acquisition unit 312a acquires a plurality of pieces of pressure data detected by the plurality of first pressure sensors 44 and stores the pressure data in the training data set storage unit 313a. Then, the learned-model generation unit 314a generates the learned model by performing the machine learning in which the plurality of pieces of pressure data are used as the training data set. Thus, the learned-model generation unit 314a can generate the learned model that has the high correlation between the shape data (roundness data) and the difference or the variation in the degree of contraction due to the positions of the molten material in the cavity C. Accordingly, the shape prediction system 100a can generate the highly precise learned model. As a result, it is possible to improve the precision of the shape prediction of the molded item.

### (8. Quality Prediction Systems 100 and 200 of Second Example)

A mass prediction system 100b which is a second example of the quality prediction systems 100 and 200 will be described. The mass prediction system 100b is a quality prediction system predicting the mass of a molded item molded by the molding machine 1.

### (8-1. Pressure Data in Mass Prediction System 100b)

The pressure data detected by the first pressure sensor 44a and the second pressure sensor 45 from the injection filling step via the pressure-keeping step to the cooling step will be described with reference to FIG. 10. FIG. 10 illustrates a graph indicating pressure transition data at the time of molding a molded item molded under a predetermined molding condition from the injection filling step to the cooling step. T1, T2, and T3 are the same as those in FIGS. 7A and 7B. Hereinafter, pressure data in the pressure-keeping process is defined as “pressure-keeping process pressure data” and a relation between a time elapsed after the pressure-keeping process and the pressure data in the pressure-keeping process is defined as “pressure-keeping process transition data.”

Here, it can be understood that the mass of the molded item has correlation with the pressure-keeping process pressure data. Specifically, there is a relation in which the mass of the molded item is larger as a time of the pressure-keeping process is longer. In addition, there is a relation in which the mass of the molded item is larger as the pressure-keeping force in the pressure-keeping process is larger. Further, there is a relation in which the mass of the molded item is less as a variation in the pressure-keeping process transition data is larger.

A pressure applied from the molten material in the supply passage 4c of the mold 4 has higher correlation with a pressure applied from the injection device 3 in the pressure-keeping process as the pressure is closer to the nozzle 34, compared to a pressure applied from the molten material in the cavity C. A pressure received by the first pressure sensor 44a in the cavity C from the molten material is less than a pressure applied from in the molten material in the supply passage 4c as a pressure loss occurs. That is, a pressure-keeping force is less in the pressure-keeping pressure data of the first pressure sensor 44a than in the pressure-keeping pressure data of the second pressure sensor 45. It is meant that the pressure loss is larger as a difference between both the pressure-keeping forces is larger. As a result, the mass of the molded item is considered to decrease.

### (8-2. Configuration of Mass Prediction System 100h)

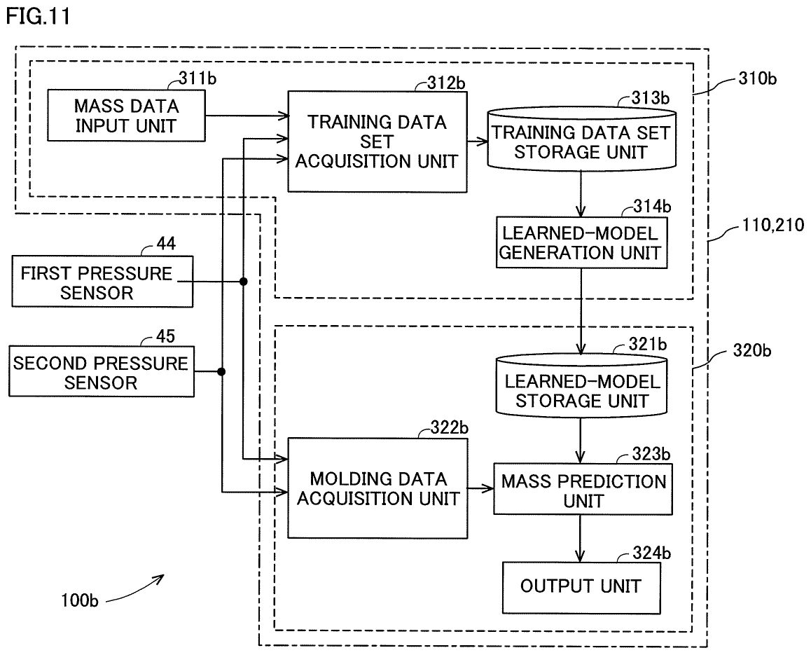

Next, a configuration of the mass prediction system 100b will be described with reference to FIG. 11. As illustrated in FIG. 11, the mass prediction system 100b includes the plurality of molding machines 1 (illustrated in FIGS. 1 and 2), a learning processing device 310b, and a mass prediction device 320b. The learning processing device 310b includes a mass data input unit 311b, a training data set acquisition unit 312b, a training data set storage unit 313b, and a learned-model generation unit 314b.

The mass data input unit 311b is an example of the quality element data input unit 311, and a measured value of the mass of a molded item molded by the molding machine 1 is input as quality element data to the mass data input unit 311b. The training data set acquisition unit 312b acquires the mass data of the molded item input to the mass data input unit 311b as the quality element data. The training data set acquisition unit 312b collects the pressure data detected by the first pressure sensor 44a and the second pressure sensor 45 in the pressure-keeping process in each of the plurality of molding machines 1 as the pressure-keeping process pressure data. The acquired training data set is stored in the training data set storage unit 313b.

The learned-model generation unit 314b generates a learned model related to the pressure-keeping process pressure data and the mass of the molded item by performing machine learning in which the associated pressure-keeping process pressure data and the mass data are used as a training data set based on the pressure-keeping process pressure data and the mass data stored in the training data set storage unit 313b.

The mass prediction device 320b is an example of the quality prediction device 320. The mass prediction device 320b includes a learned-model storage unit 321b, a molding data acquisition unit 322b, a mass prediction unit 323b, and an output unit 324b. The learned-model storage unit 321b stores the learned model generated by the learned-model generation unit 314b. The molding data acquisition unit 322b acquires the pressure-keeping process pressure data detected by the first pressure sensor 44a and the second pressure sensor 45 when the molding machine 1 newly molds a molded item. The mass prediction unit 323b which is an example of the quality prediction unit 323 predicts the mass of the molded item which is newly molded based on the pressure-keeping process pressure data (the pressure-keeping process transition data) acquired by the molding data acquisition unit 322b and the learned model stored in the learned-model storage unit 321b.

In the mass prediction system 100b which is the quality prediction system 100 of the second example, the training data set acquisition unit 312b and the molding data acquisition unit 322b acquire only pressure data of the first pressure sensor 44a among the six first pressure sensors 44a to 44f as the pressure-keeping process pressure data, but the present invention is not limited thereto. That is, the training data set acquisition unit 312b and the molding data acquisition unit 322b may acquire pressure data from the first pressure sensors 44b to 44f other than the first pressure sensor 44a as the pressure-keeping process pressure data.

The training data set acquisition unit 312b and the molding data acquisition unit 322b may acquire pressure data as the pressure-keeping process pressure data from the plurality of first pressure sensors 44a to 44f. In this case, the training data set acquisition unit 312b and the molding data acquisition unit 322b preferably acquire the pressure data including pressure data of the first pressure sensor 44a disposed at the farthest position from the gate 43 among the six first pressure sensors 44a to 44f.

That is, since the first pressure sensor 44a is disposed at the farthest position from the gate 43 in the inflow path, a pressure loss of a pressure of the molten material received from the first pressure sensor 44a is the largest in the molten material with which the cavity C is filled. Accordingly, a difference between the pressure-keeping process pressure data of the first pressure sensor 44a and the pressure-keeping process pressure data of the second pressure sensor 45 is considered to be easily larger than a difference between the pressure-keeping process pressure data of the other first pressure sensors 44b to 44f and the pressure-keeping process pressure data of the second pressure sensor 45. Accordingly, when the pressure data acquired from some of the plurality of first pressure sensors 44a to 44f and the pressure data of the second pressure sensor 45 are set as the pressure-keeping process pressure data, the learned-model generation unit 314b can generate the learned model with high precision and the mass prediction unit 323b can improve the prediction precision of the mass of the molded item by including the pressure data of the first pressure sensor 44a.

The training data set acquisition unit 312b and the molding data acquisition unit 322b may acquire the pressure data detected from at least one of the six first pressure sensors 44a to 44f as the pressure-keeping process pressure data. That is, the learned-model generation unit 314b may generate the learned model without using the pressure-keeping process pressure data of the second pressure sensor 45 as the training data set. In this case, the learned-model generation unit 314b can also generate the learned model in which the pressure-keeping process pressure data of the first pressure sensor 44 and the mass data of the molded item are used as the training data set. Accordingly, the mass prediction unit 323b can predict the mass of a molded item which is newly molded based on the pressure-keeping process pressure data (pressure-keeping process transition data) newly obtained from the first pressure sensor 44.

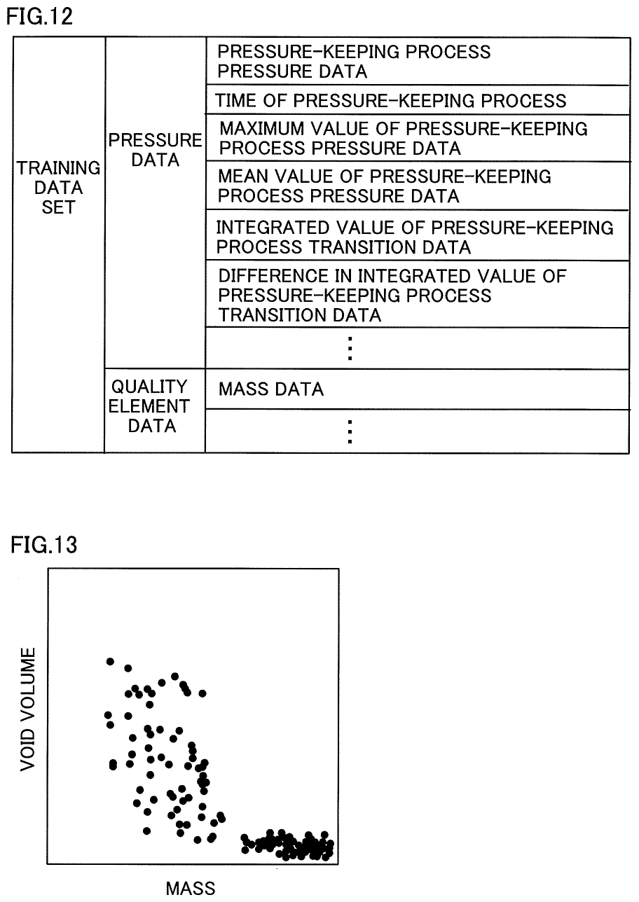

Next, an example of the training data set used when the learned-model generation unit 314b generates the learned model will be described with reference to FIG. 12. The learned-model generation unit 314b uses not only the pressure-keeping process pressure data of the pressure sensors 44 and 45 but also a statistical amount obtained from the pressure-keeping process transition data as the training data set.

For example, as illustrated in FIG. 12, the training data set includes an integrated value obtained by integrating the pressure-keeping process transition data with respect to time. In this way, by using the integrated value as the training data set, the learned-model generation unit 314b can ascertain the training data set accurately, and therefore it is possible to achieve high precision of the learned model.

The training data set includes a time of the pressure-keeping process, a maximum value, a mean value, or the like of the pressure-keeping process pressure data. In this case, the learned-model generation unit 314b can generate a learned model in which a difference in the degree of influence on the mass of the molded item between the pressure-keeping force and time in the pressure-keeping process is reflected, and therefore it is possible to achieve high precision of the learned model.

Further, the training data set includes a statistical amount indicating a variation in the pressure-keeping process pressure data among the plurality of pressure sensors 44 and 45. As described above, there is a relation in which the mass of the molded item decreases as the variation in the pressure-keeping process pressure data is larger. Accordingly, by including the statistical amount indicating the variation as the training data set, the learned-model generation unit 314b can generate the learned model in which correlation between the variation and the mass of the molded item is high.

Examples of the statistical amount indicating the variation in the pressure-keeping process pressure data include a difference in the pressure-keeping process pressure data of the plurality of pressure sensors 44 and 45, a dispersion of the plurality of pieces of pressure-keeping process pressure data, a difference in a temporal integrated value of the plurality of pieces of pressure-keeping process transition data, a dispersion of the temporal integrated value of the pressure-keeping process transition data, a difference in the mean value of the temporal derivative values of the pressure-keeping process transition data, and a dispersion of the mean value of the temporal derivative values of the pressure-keeping process transition data.

As described above, the learned-model generation unit 314b generates a learned model by performing machine learning in which the pressure-keeping process pressure data of the pressure sensors 44 and 45 and the mass data are used as a training data set. Accordingly, the learned-model generation unit 314b can generate the learned model with high correlation among the pressure-keeping force received by the molten material with which the cavity C is filled in the pressure-keeping process, a time of the pressure-keeping process, and the mass data.

The learned-model generation unit 314b generates the learned model by performing the machine learning in which the pressure-keeping transition data of the first pressure sensors 44, the pressure-keeping process transition data of the second pressure sensor 45, and the mass data are used as a training data set. Thus, the learned-model generation unit 314b can generate the learned model in which correlation among the pressure received by the molten material with which the cavity C is filled in the pressure-keeping process, the pressure time, and the mass data is clear, and therefore it is possible to achieve high precision of the learned model.

### (9. Quality Prediction Systems 100 and 200 of Third Example)

A void volume prediction system 100c which is a third example of the quality prediction systems 100 and 200 will be described. The void volume prediction system 100c is a quality prediction system that predicts a void volume of a molded item molded by the molding machine 1.

### (9-1. Molding Data in Void Volume Prediction System 100c)

It can be understood that the void volume of a molded item has the correlation with the mass of the molded item. The correlation between the void volume and the mass is illustrated in FIG. 13. That is, the molded item molded by the same mold 4 has a relation in which the void volume is smaller as the mass is larger. In particular, when the mass is equal to or greater than a predetermined value, the void volume is a value close to 0. Conversely, when the mass is equal to or less than the predetermined value, the molded item has a relation in which the void volume is smaller as the mass is larger although there is a variation.

Here, in the above-described mass prediction system 100b, the mass of the molded item has correlation with the pressure-keeping process pressure data. Specifically, there is a relation in which the mass of the molded item is larger as the time of the pressure-keeping process is longer. In addition, there is a relation in which the mass of the molded item is larger as the pressure-keeping force in the pressure-keeping process is larger. Further, there is a relation in which the mass of the molded item decreases as a variation in the pressure-keeping process transition data is larger. Further, in the pressure-keeping process pressure data of the first pressure sensor 44a, the pressure-keeping force is less than in the pressure-keeping process pressure data of the second pressure sensor 45. It is meant that the pressure loss is larger as a difference between both the pressure-keeping forces is larger. As a result, the mass of the molded item is considered to decrease. That is, based on the relation between the mass of the molded item and the pressure-keeping process pressure data and the relation between the mass and the void volume, a relation between the void volume and the pressure-keeping process pressure data can be deduced.

The void volume has correlation with a temperature of the molten material. As a difference between the temperature of the molten material and a temperature after cooling is smaller, a contraction amount of a resin decreases. Therefore, the void volume tends to decrease. Conversely, as a difference between the temperature of the molten material and a temperature after cooling is larger, the contraction amount of the resin increases. Therefore, the void volume tends to increase.

### (9-2. Configuration of Void Volume Prediction System 100c)

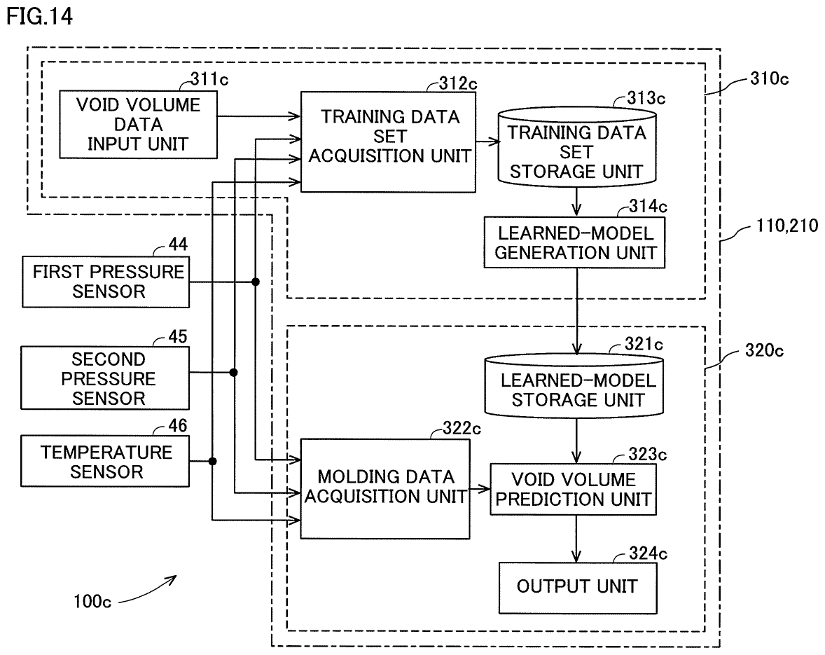

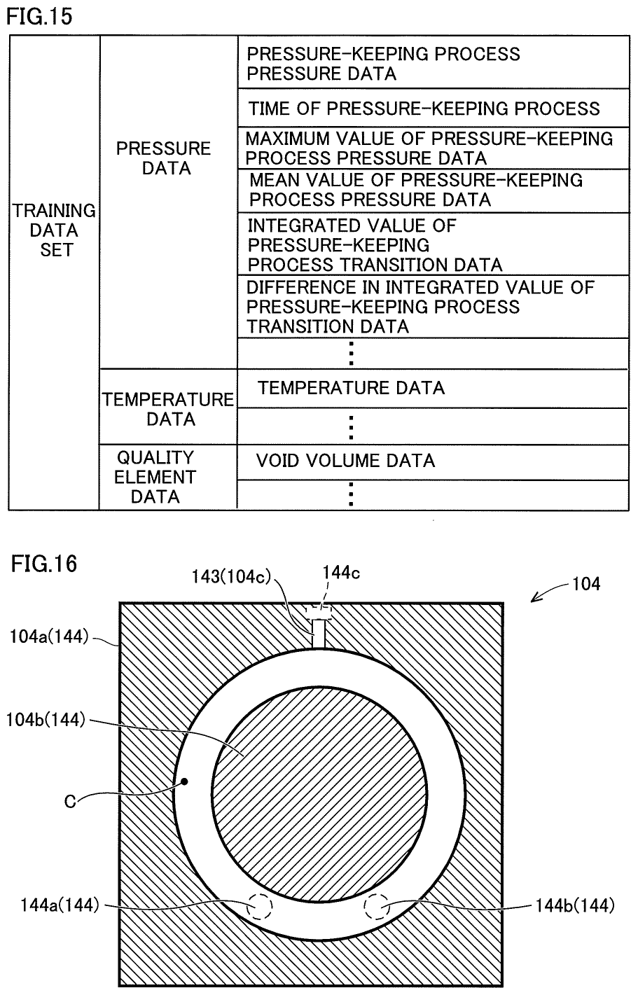

Next, a configuration of the void volume prediction system 100c will be described with reference to FIG. 14. As illustrated in FIG. 14, the void volume prediction system 100c includes the plurality of molding machines 1 (illustrated in FIGS. 1 and 2), a learning processing device 310c, and a void volume prediction device 320c. The learning processing device 310c includes a void volume data input unit 311c, a training data set acquisition unit 312c, a training data set storage unit 313c, and a learned-model generation unit 314c.

The void volume data input unit 311c is an example of the quality element data input unit 311, and a measured value of the void volume of a molded item molded by the molding machine 1 is input as quality element data to the void volume data input unit 311c. Here, the void volume can be measured by an X-ray CT, an ultrasonic ray, optical coherence tomography, or the like. The void volume measured by such a scheme is input as quality element data to the void volume data input unit 311c.

The training data set acquisition unit 312c acquires the void volume data of the molded item input as the quality element data to the void volume data input unit 311c. The training data set acquisition unit 312c collects the pressure data detected by the first pressure sensor 44a and the second pressure sensor 45 in the pressure-keeping process in each of the plurality of molding machines 1 as the pressure-keeping process pressure data. Further, the training data set acquisition unit 312c collects the temperature data detected by the temperature sensor 46 in the pressure-keeping process in each of the plurality of molding machines 1. The acquired training data set is stored in the training data set storage unit 313c.

The learned-model generation unit 314c generates a learned model related to the pressure-keeping process pressure data and the void volume of the molded item by performing machine learning in which the associated pressure-keeping process pressure data and the void volume data are used as a training data set based on the pressure-keeping process pressure data, the temperature data, and the void volume data stored in the training data set storage unit 313c.

The void volume prediction device 320c is an example of the quality prediction device 320. The void volume prediction device 320c includes a learned-model storage unit 321c, a molding data acquisition unit 322c, a void volume prediction unit 323c, and an output unit 324c. The learned-model storage unit 321c stores the learned model generated by the learned-model generation unit 314c. The molding data acquisition unit 322c acquires the pressure-keeping process pressure data detected by the first pressure sensor 44a and the second pressure sensor 45 when the molding machine 1 newly molds a molded item. Further, the molding data acquisition unit 322c acquires the temperature data detected by the temperature sensor 46 when the molding machine 1 newly molds a molded item.

The void volume prediction unit 323c which is an example of the quality prediction unit 323 predicts a void volume of the molded item which is newly molded based on the pressure-keeping process pressure data (the pressure-keeping process transition data) acquired by the molding data acquisition unit 322c, the temperature data, and the learned model stored in the learned-model storage unit 321c.

The training data set acquisition unit 312c and the molding data acquisition unit 322c may acquire pressure data from the plurality of first pressure sensors 44a to 44f as the pressure-keeping process pressure data. In this case, the training data set acquisition unit 312c and the molding data acquisition unit 322c preferably acquire the pressure data including pressure data of the first pressure sensor 44a disposed at the farthest position from the gate 43 among the six first pressure sensors 44a to 44f.

That is, since the first pressure sensor 44a is disposed at the farthest position from the gate 43 in the inflow path, a pressure loss of a pressure of the molten material received from the first pressure sensor 44a is the largest in the molten material with which the cavity C is filled. Accordingly, a difference between the pressure-keeping process pressure data of the first pressure sensor 44a and the pressure-keeping process pressure data of the second pressure sensor 45 is considered to be easily larger than a difference between the pressure-keeping process pressure data of the other first pressure sensors 44b to 44f and the pressure-keeping process pressure data of the second pressure sensor 45. Accordingly, when the pressure data acquired from some of the plurality of first pressure sensors 44a to 44f and the pressure data of the second pressure sensor 45 are set as the pressure-keeping process pressure data, the learned-model generation unit 314c can generate the learned model with high precision and the void volume prediction unit 323c can improve the prediction precision of the void volume of the molded item by including the pressure data of the first pressure sensor 44a.

The training data set acquisition unit 312c and the molding data acquisition unit 322c may acquire the pressure data detected from at least one of the six first pressure sensors 44a to 44f as the pressure-keeping process pressure data. That is, the learned-model generation unit 314c may generate the learned model without using the pressure-keeping process pressure data of the second pressure sensor 45 as the training data set. In this case, the learned-model generation unit 314c can also generate the learned model in which the pressure-keeping process pressure data of the first pressure sensor 44 and the void volume data of the molded item are used as the training data set. Accordingly, the void volume prediction unit 323c can predict the void volume of a molded item which is newly molded based on the pressure-keeping process pressure data (pressure-keeping process transition data) newly obtained from the first pressure sensor 44.

The void volume prediction unit 323c can also perform quality determination of the molded item based on a predicted value of the void volume and a preset allowable value. Further, the void volume prediction unit 323c can also determine the strength of the molded item based on the predicted value of the void volume. In this case, the void volume prediction unit 323c may perform quality determination on the molded item after the molded item is molded by the molding machine 1 and before a subsequent step of the molding step by the molding machine 1 is performed.

Next, an example of the training data set used when the learned-model generation unit 314c generates the learned model will be described with reference to FIG. 14. The learned-model generation unit 314c uses not only the pressure-keeping process pressure data of the pressure sensors 44 and 45 but also a statistical amount obtained from the pressure-keeping process transition data as the training data set.

For example, as illustrated in FIG. 14, the training data set includes an integrated value obtained by integrating the pressure-keeping process transition data with respect to time. In this way, by using the integrated value as the training data set, the learned-model generation unit 314c can ascertain the training data set accurately, and therefore it is possible to achieve high precision of the learned model.

The training data set includes a time of the pressure-keeping process, a maximum value, a mean value, or the like of the pressure-keeping process pressure data. In this case, the learned-model generation unit 314c can generate a learned model in which a difference in the degree of influence on the void volume of the molded item between the pressure-keeping force and time in the pressure-keeping process is reflected, and therefore it is possible to achieve high precision of the learned model.

Further, the training data set includes a statistical amount indicating a variation in the pressure-keeping process pressure data among the plurality of pressure sensors 44 and 45. As described above, there is a relation in which the void volume of the molded item decreases as the variation in the pressure-keeping process pressure data is larger. Accordingly, by including the statistical amount indicating the variation as the training data set, the learned-model generation unit 314c can generate the learned model in which correlation between the variation and the void volume of the molded item is high.

Examples of the statistical amount indicating the variation in the pressure-keeping process pressure data include a difference in the pressure-keeping process pressure data of the plurality of pressure sensors 44 and 45, a dispersion of the plurality of pieces of pressure-keeping process pressure data, a difference in a temporal integrated value of the plurality of pieces of pressure-keeping process transition data, a dispersion of the temporal integrated value of the pressure-keeping process transition data, a difference in the mean value of the temporal derivative values of the pressure-keeping process transition data, and a dispersion of the mean value of the temporal derivative values of the pressure-keeping process transition data.

As described above, the learned-model generation unit 314c generates a learned model by performing machine learning in which the pressure-keeping process pressure data of the pressure sensors 44 and 45, the temperature data, and the void volume data are used as a training data set. Accordingly, the learned-model generation unit 314c can generate the learned model with high correlation among the pressure-keeping force received by the molten material with which the cavity C is filled in the pressure-keeping process, a time of the pressure-keeping process, the temperature of the molten material in the pressure-keeping process, and the void volume data.

The learned-model generation unit 314c generates the learned model by performing the machine learning in which the pressure-keeping process pressure data of the first pressure sensors 44, the pressure-keeping process pressure data of the second pressure sensor 45, the temperature data of the temperature sensor 46, and the void volume data are used as a training data set. Thus, the learned-model generation unit 314c can generate the learned model in which correlation among the pressure received by the molten material with which the cavity C is filled in the pressure-keeping process, the pressure-keeping time, the temperature of the molten material, and the void volume data is clear, and therefore it is possible to achieve high precision of the learned model.

### (10. Mold 104 of Second Example and Material Temperature Sensors 144a to 144c)

Next, material temperature sensors 144a to 144c disposed in the mold 104 of the second example will be described with reference to FIG. 16. As illustrated in FIG. 16, in the mold 104, the three material temperature sensors 144a to 144c detecting a temperature of the supplied molten material are provided in the cavity C and the supply passage 104c. In the embodiment, the material temperature sensors 144a to 144c are provided in a first mold 104a, but can also be provided in a second mold 104b. The material temperature sensors 144a to 144c may be contact sensors or may be contactless sensors. In the mold 104, at least one material temperature sensor may be provided. In this case, the material temperature sensor is preferably provided in the cavity C.

Of the three material temperature sensors 144a to 144c provided in the mold 104, two material temperature sensors 144a and 144b are provided in the cavity C and the remaining one material temperature sensor 144c is provided in the supply passage 104c. The two material temperature sensors 144a and 144b provided in the cavity Care disposed at positions which are bilaterally symmetric positions and are positions at which distances from the gate 143 are equal. The two material temperature sensors 144a and 144b are disposed closer to the farthest position from the gate 143 than the intermediate position in the inflow path.

Here, in the injection filling step when a molded item is molded, a temperature of the molten material supplied to the mold 104 increases due to shear heating. Then, when the molten material branching and moving in two directions in the cavity C joins, a heating amount increases due to the shear heating of the molten material, and thus the temperature of the molten material is considered to be the highest. That is, the temperature of the molten material is considered to be the highest near the farthest position at which the molten material branching and moving in the two directions in the cavity C joins. It is considered that the highest temperature of the molten material in the cavity C can be ascertained by disposing the two material temperature sensors 144a and 144b disposed in the cavity C near the farthest position.

With regard to this point, the two material temperature sensors 144a and 144b are disposed close to the farthest position from the gate 143. That is, since the two material temperature sensors 144a and 144b are disposed near the farthest position, it is possible to ascertain the largest value of the molten material in the cavity C. The two material temperature sensors 144a and 144b in the cavity C are disposed to be bilateral symmetric. Thus, even when the molten material joins at a position deviating from the farthest position, the highest temperature of the molten material in the cavity C can be ascertained by acquiring higher temperature between temperatures detected by the two material temperature sensors 144a and 144b.

When the shape of the cavity C is not annular, a material temperature sensor is preferably disposed at a position at which the temperature of the molten material is highest. For example, when the molten material moving in the cavity comes into contact with a wall surface forming the cavity and the molten material reaches the highest temperature, the highest temperature of the molten material in the cavity can be ascertained by disposing a material temperature sensor near the wall surface.

### (11. Each Configuration of Quality Prediction System 300 of Fourth Example)

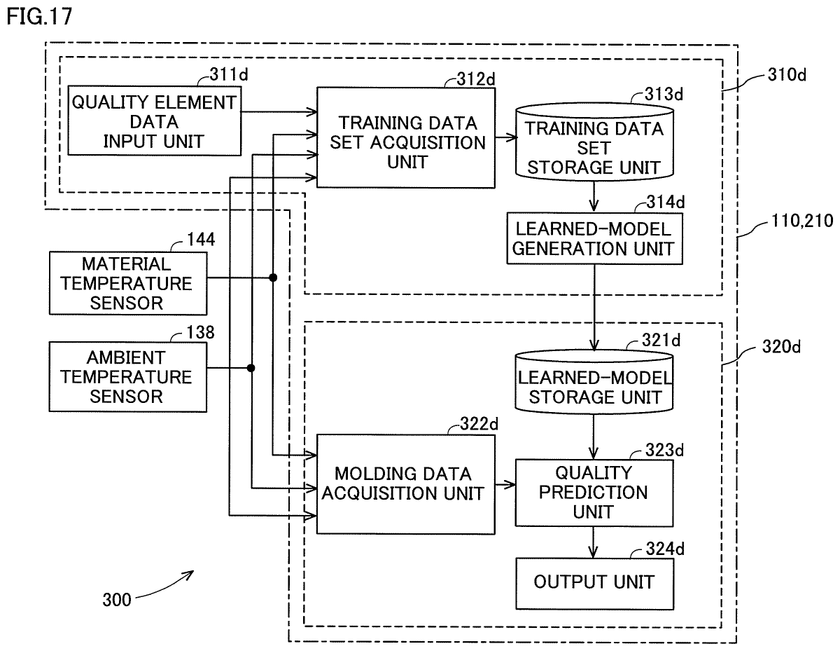

Next, each configuration of the quality prediction system 300 of a fourth example will be described with reference to FIG. 17. A quality prediction system 300 of the fourth example includes material temperature sensors 144a to 144c, an ambient temperature sensor 138, and machine learning devices 110 and 210. Since the machine learning devices 110 and 210 have a similar configuration to the foregoing example, the same reference numerals are given. That is, the machine learning devices 110 and 210 include a learning processing device 310d capable of performing a learning phase and a quality prediction device 320d capable of performing a reasoning phase.

The learning processing device 310d will be described. The learning processing device 310d includes a quality element data input unit 311d, a training data set acquisition unit 312d, a training data set storage unit 313d, and a learned model generation unit 314d.

The training data set acquisition unit 312d acquires molding data such as material temperature data detected by the material temperature sensors 144a to 144c provided in the molding machine 1 and ambient temperature data detected by the ambient temperature sensor 138, and the quality element data input to the quality element data input unit 311d as a training data set. The acquired training data set is stored in the training data set storage unit 313d.

The learned-model generation unit 314d generates a learned model related to the molding data and the quality element of the molded item by performing machine learning in which the associated molding data and quality element data are used as a training data set based on the molding data (material temperature data or ambient temperature data) and the quality element data stored in the training data set storage unit 313d.

In particular, the learned model generation unit 314d uses a temperature of the molten material when the mold 104 is opened in a state in which the molten material is supplied to the cavity C (hereinafter referred to as “first temperature data Th1”) among the pieces of material temperature data detected by the material temperature sensors 144a to 144c. The first temperature data Th1 is a temperature of the molten material when the cooling step proceeds to the release extraction step and is a temperature when the first mold 104a is separated from the second mold 104b (a temperature at the time of opening the mold).

Further, the learned model generation unit 314d uses the highest temperature of the molten material (hereinafter referred to as “second temperature data Th2”) among the pieces of material temperature data detected by the material temperature sensors 144a to 144c. The second temperature data Th2 is the highest temperature of the molten material (highest material temperature) detected by each of the material temperature sensors 144a to 144c from start of supply of the molten material to the mold 104 to end of the cooling step.

The learned model generation unit 314d may not necessarily use all of the pieces of first temperature data Th1 detected by the three material temperature sensors 144a to 144c. For example, the learned model generation unit 314d can also use only a detection result detected by one of the two material temperature sensors 144a and 144b disposed in the cavity C. The learned model generation unit 314d may not necessarily use both the first temperature data Th1 and the second temperature data Th2 and can also use one of the first temperature data Th1 and the second temperature data Th2.

When the molded item is extracted from the mold 104 in the release extraction step or when the molded item is extracted from the mold 104 and then a predetermined time elapses, the learned model generation unit 314d can also use a detection result detected by the material temperature sensors 144a to 144c as an ambient temperature data Th3. In this case, the ambient temperature sensor 138 can be unnecessary.

That is, the learned model generation unit 314d generates a learned model related to the quality element of the molded item, the pieces of material temperature data Th1 and Th2, and the ambient temperature data Th3 by performing machine learning in which the quality element of the molded item, the pieces of material temperature data Th1 and Th2, and the ambient temperature data Th3 are used as a training data set based on the quality element of the molded item, the pieces of material temperature data Th1 and Th2, and the ambient temperature data Th3. In particular, the learned model generation unit 314d generates a learned model which is a relation between the first temperature data Th1 and the second temperature data Th2 by performing machine learning using the first temperature data Th1 and the second temperature data Th2 as the material temperature data.

Next, the quality prediction device 320d will be described. The quality prediction device 320d mainly includes a learned-model storage unit 321d, a molding data acquisition unit 322d, a quality prediction unit 323d, and an output unit 324d. The learned-model storage unit 321d stores the learned model generated by the learned-model generation unit 314d. When the molding machine 1 newly molds a molded item, the molding data acquisition unit 322d acquires the molding data detected by the material temperature sensors 144a to 144c, the ambient temperature sensor 138, and the like.

The quality prediction unit 323d predicts a quality element of the molded item which is newly molded based on the molding data acquired by the molding data acquisition unit 322d and the learned model stored in the learned-model storage unit 321d. In particular, the quality prediction unit 323d predicts the quality element using the first temperature data Th1 and the second temperature data Th2 as the material temperature data. The quality element predicted by the quality prediction unit 323d is included in the quality element input as the quality element data to the quality element data input unit 311d.

The quality prediction unit 323d can perform quality determination on the molded item based on the predicted quality element and a preset allowable value. In this case, the quality prediction unit 323d may perform quality determination on the molded item after the molded item is molded by the molding machine 1 and before a subsequent step of the molding step by the molding machine 1 is performed. The output unit 324d outputs a prediction result by the quality prediction unit 323d. The output unit 324d performs a similar process to the process of the output unit 324 of the foregoing example.

### (12. Transition of Material Temperature Data)

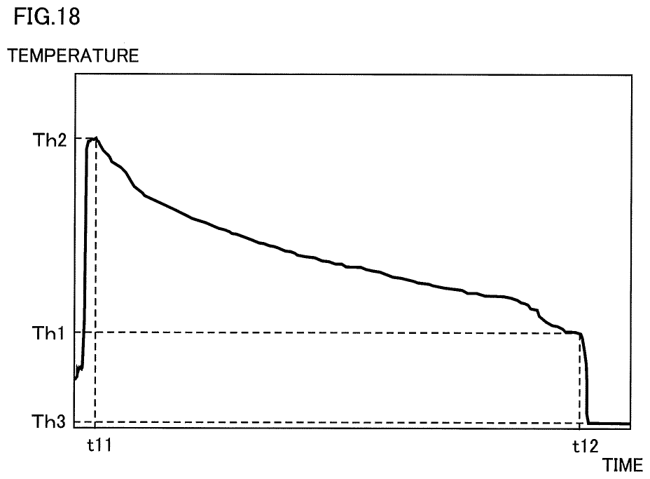

A transition of the material temperature data will be described with reference to FIG. 18. A graph illustrated in FIG. 18 is a graph illustrating an example of a transition of the material temperature data and illustrates a transition of the material temperature data detected by the material temperature sensor 144a provided in the cavity C.

In the graph illustrated in FIG. 18, the horizontal axis represents a time elapsed after supply of the molten material to the mold 104 starts and the vertical axis represents a detected value (a temperature of the molten material) by the material temperature sensor 144a. Time t11 on the horizontal axis indicates a time at which the material temperature sensor 144a detects the second temperature data Th2 during the supply of the molten material to the cavity C. Time t12 is a time at which the mold 104 is opened and the temperature of the molten material at time t12 is the first temperature data Th1. In the example illustrated in FIG. 18, the first temperature data Th1 is nearly equal to the temperature of the heated mold 104. Th3 on the vertical axis indicates ambient temperature data.

As illustrated in FIG. 18, a detected value by the material temperature sensor 144a sharply increases at a time point at which the molten material reaches a position at which the material temperature sensor 144a is disposed. At this time, the molten material moving in the cavity C heats due to shear heating and its temperature becomes higher than the temperature of the mold 104. Then, when the molten material branching and moving in two directions in the cavity C joins, the heating amount of the molten material further increases due to the shear heating, and thus the temperature of the molten material becomes the highest.

Thereafter, when the heat of the molten material due to the shear heating settles down, the temperature of the molten material gradually decreases and approaches the temperature of the mold 104. When the temperature of the molten material decreases to the heating temperature of the mold 104 until time t12, the temperature of the molten material thereafter becomes nearly constant.

In this case, when a time in which the temperature of the molten material remains unchanged until time t12 is long, it is considered that it is possible to achieve shortening of a cycle time by shortening the cooling step. When the mold is opened, the molten material supplied to the mold 104 is exposed to the ambient air, and therefore the temperature of the molten material suddenly decreases. Then, the molten material in the cavity C considerably contracts with the sudden decrease in the temperature of the molten material after the mold is opened. With regard to this point, the contraction amount of the molten material is considerable as a difference between the temperature of the molten material at time t12 and the ambient temperature of a place in which the molding machine 1 is disposed is large. Therefore, when a temperature difference between the first temperature data Th1 and the heating temperature of the mold 104 is large, the quality element of the molded item becomes unstable in some cases. Accordingly, in this case, by delaying time t12 and lengthening the cooling step, it is possible to stabilize the quality element of the molded item.

Accordingly, the quality prediction device 320d predicts the contraction amount of the molten material after the mold is opened based on the first temperature data Th1 which is the temperature of the molten material at the time of opening the mold and predicts the quality element of the molded item which is molded when the molten material is solidified. That is, in the quality prediction system 300, the learning processing device 310d generates a learned model indicating a relation between the first temperature data Th1 and the quality element of the molded item. Then, the quality prediction device 320d predicts the quality element of the molded item based on the learned model generated by the learning processing device 310d and the first temperature data Th1 at the time of molding the molded item. Thus, the quality prediction system 300 can predict the quality element of the molded item with high precision.

The quality prediction device 320d may predict the quality element of the molded item based on the learned model indicating a relation among the first temperature data Th1, the ambient temperature data Th3, and the quality element of the molded item, and the first temperature data Th1 and the ambient temperature data Th3 at the time of molding the molded item. That is, even when the first temperature data Th1 is constant, a difference between the first temperature data Th1 and the ambient temperature data Th3 differs between a warm case of the place at which the molding machine 1 is disposed and a cool case of the place. In the quality prediction system 300, the learning processing device 310d generates the learned model indicating the relation among the first temperature data Th1, the ambient temperature data Th3, and the quality element of the molded item. Then, the quality prediction device 320d predicts the quality element of the molded item based on the learned model generated by the learning processing device 310d, and the first temperature data Th1 and the ambient temperature data Th3 at the time of forming the molded item. Thus, the quality prediction system 300 can predict the quality element of the molded item with high precision.

The second temperature data Th2 has an influence on the first temperature data Th1. That is, as the second temperature data Th2 is higher, a time necessary to decrease the temperature of the molten material to the heating temperature of the mold 104 is longer. When time t12 is constant and the second temperature data Th2 exceeds a predetermined temperature, a difference between the first temperature data Th1 and the temperature of the mold 104 is larger as the second temperature data Th2 is a higher temperature. That is, the temperatures of the first temperature data Th1 and the ambient temperature data Th3 increase and the molten material considerably contracts. In this way, the second temperature data Th2 is considered to be useful information when the contraction amount of the molten material after the opening of the mold is predicted with high precision.

Accordingly, in the quality prediction system 300, the learning processing device 310d generates the learned model indicating a relation among the first temperature data Th1, the second temperature data Th2, and the quality element of the molded item. Then, the quality prediction device 320d predicts the quality element of the molded item based on the learned model generated by the learning processing device 310d and the first temperature data Th1 and the second temperature data Th2 at the time of molding the molded item. Thus, the quality prediction system 300 can predict the quality element of the molded item with higher precision.

The molten material expands when the molten material is heated. The molten material contracts when the molten material is cooled. Accordingly, as the second temperature data Th2 is a higher temperature, an expansion amount of the molten material supplied to the mold 104 increases. As a result, the mass of the molten material with which the cavity C can be filled in the injection filling process becomes small. In this case, when the molten material in the cavity C is cooled, the molten material considerably contracts with respect to the cavity C. In contrast, when the second temperature data Th2 is a lower temperature, an expansion amount of the molten material in the cavity C decreases and the mass of the molten material with which the cavity C can be filled in the injection filling step increases. In this case, a contraction amount of the molten material in the cavity C at the time of cooling decreases with respect to the cavity C.

That is, by ascertaining the second temperature data Th2, it is possible to predict the mass of the molten material supplied to the cavity C. As a result, the quality element of the molded item molded when the molten material is solidified can be considered to be predicted. Accordingly, in the quality prediction system 300, the learning processing device 310d generates the learned model indicating a relation between the second temperature data Th2 and the quality element of the molded item. Then, the quality prediction device 320d predicts the quality element of the molded item based on the learned model generated by the learning processing device 310d and the second temperature data Th2 at the time of molding the molded item. Thus, the quality prediction system 300 can predict the quality element of the molded item with higher precision.

The temperature of the molten material is considered to have low relevance to the first temperature data Th1 and the ambient temperature data Th3. Accordingly, when the learning processing device 310d generates the learned model, it is possible to avoid using the first temperature data Th1 and the ambient temperature data Th3 as a training data set. In this case, since the quality prediction device 320d performs quality prediction of the molded item based on the second temperature data Th2 with high relevance to the mass of the molten material, it is possible to improve prediction precision.

The material temperature sensor 144a is disposed near the farthest position at which the molten materials branching and moving in two directions are considered to join (see FIG. 16). Accordingly, in the quality prediction system 300, the temperature of the molten material assumed to be the highest temperature in the molten material supplied to the cavity C can be detected by the material temperature sensor 144a. That is, the material temperature sensor 144a is disposed at the position at which the temperature of the molten material is the highest in the inflow path in which the molten material flows from the gate 143 in the cavity C. Then, the quality prediction device 320d can predict the quality element of the molded item with high precision by predicting the quality element of the molded item based on the temperature and the learned model.

Even when the shape of the cavity C is not annular, the transition of the material temperature data is nearly similar to the example illustrated in FIG. 18. That is, the temperature of the molten material becomes the highest while the molten material is supplied to the cavity C. When the heat due to the shear heating settles down, the temperature of the molten material gradually decreases and approaches the temperature of the mold.

### (13. Prediction of Quality Element of Molded Item Using Quality Prediction System 300 of Fourth Example)

Next, prediction of the quality element of the molded item in which the quality prediction system 300 of the fourth example is used will be described giving specific examples.

### (13-1. First Specific Example of Quality Prediction System 300 of Fourth Example)

First, a case in which the quality prediction device 320d predicts a dimension of a molded item molded by the molding machine 1 will be described as a first specific example of the fourth example. In this example, a case in which the quality prediction device 320 predicts an outer diameter of a molded item which is molded annularly will be described as an example. However, another dimension (an inner diameter, an axial length, or the like) of the molded item can also be predicted.

In this example, the training data set acquisition unit 312d acquires quality element data related to the outer diameter of the molded item, material temperature data related to the first temperature data Th1 and the second temperature data Th2, and the ambient temperature data Th3 as a training data set. Subsequently, the learned model generation unit 314d generates a learned model indicating a relation among the quality element data, the pieces of material temperature data Th1 and Th2, and the ambient temperature data Th3 by machine learning in which the acquired various piece of data is used as the training data set.

Then, the quality prediction device 320 predicts an outer diameter of a molded item which is newly molded based on the learned model generated by the learned model generation unit 314d, the material temperature data (the first temperature data Th1 and the second temperature data Th2) obtained when the molded item is newly generated, and the ambient temperature data Th3.

In this example, the learned model generation unit 314d may not use all of the material temperature data related to the first temperature data Th1 and the second temperature data Th2 and the ambient temperature data Th3 as the training data set. That is, the learned model generation unit 314d may use at least the first temperature data Th1 as the training data set. Even in this case, the quality prediction device 320d can predict the dimension of the molded item which is newly molded with high precision based on the learned model and the material temperature data related to the first temperature data Th1.

### (13-2. Second Specific Example of Quality Prediction System 300 of Fourth Example)

Next, a case in which a shape of a molded item molded by the molding machine 1 is predicted by the quality prediction device 320d will be described as a second specific example of the fourth example. In this example, a case in which the quality prediction device 320d predicts roundness of the outer circumferential surface and the inner circumferential surface of the molded item which is formed annularly will be described as an example. However, another shape (for example, geometrical tolerance such as cylindricity or circularity) of the molded item can also be predicted.

In this example, the training data set acquisition unit 312d acquires quality element data related to the outer diameter of the molded item and material temperature data related to the second temperature data Th2 as data used for a training data set. Subsequently, the learned model generation unit 314d generates a learned model indicating a relation between the quality element data and the material temperature data by machine learning in which the acquired various kinds of data are used as the training data set.

Then, the quality prediction device 320d predicts the roundness of the molded item which is newly molded based on the learned model generated by the learned model generation unit 314d and the material temperature data (the second temperature data Th2) obtained at the time of newly generating the molded item.

### (14. Use Example of Prediction Result of Quality Element by Quality Prediction Unit 323d)

Next, a use example of a prediction result of a quality element by the quality prediction unit 323d will be described. First, in the quality prediction device 320d, the quality prediction unit 323d determines whether a molded item is a quality item based on the prediction result of the quality element. For example, the quality prediction unit 323d determines whether a dimension or a shape of the molded item obtained as the prediction result is within a preset threshold (within dimension tolerance or within geometrical tolerance). Then, the quality prediction unit 323d determines that the molded item is a quality item when the dimension or the shape of the molded item is within the threshold. Thus, a worker or the like using the quality prediction system 300 can easily determine quality of the molded item based on the quality determination result by the quality prediction unit 323d.

The worker or the operation instruction data adjustment unit 8 (see FIG. 3) can adjust the operation instruction data stored in the operation instruction unit 6 based on the prediction result of the quality element by the quality prediction device 320d. For example, when the worker or the like adjusts time t12, optimization of the cycle time and stabilization of the molded item which is a quality item can be compatible for production. Further, when the worker or the like adjusts a temperature of the heating cylinder 32 and adjusts an injection speed or the like, the adjustment of the second temperature data Th2 can be achieved. The worker or the like can also examine a design change of the supply passage 104c based on the material temperature data of the material temperature sensor 144c provided in the supply passage 104c.

### (15. Modification Aspects)

In the molding machine 1 of the shape prediction system 100a serving as the quality prediction system 100 or 200 of the first example, the six first pressure sensors 44a to 44f are disposed in the mold 4, was described as the example, but the present invention is not limited thereto. That is, the plurality of first pressure sensors 44 may be disposed in the mold 4 or the number of first pressure sensors 44 may be 5 or less or may be 7 or more.

In this case, the plurality of first pressure sensors 44 may be disposed at a plurality of positions at which distances from the gate 43 are different in the inflow path. For example, in the shape prediction system 100a, the six first pressure sensors 44a to 44f are all disposed in the right half illustrated in FIG. 4, but the first pressure sensors 44 may be disposed at any positions in the circumferential direction of the annular cavity C.

In the molding machines 1 of the quality prediction systems 100, 200, and 300, only one gate 43 or 143 is provided in one cavity C in the mold 4 or 104, but two or more gates 43 or 143 may be provided in one cavity C.

What is claimed is:

1. A quality prediction system for a molded item applied to a molding method of molding the molded item by supplying a molten material to a cavity of a mold of a molding machine, the quality prediction system comprising:
a sensor disposed in the mold and configured to detect state data regarding the molten material supplied in the cavity;
a learned-model storage unit configured to store a model which is a learned model generated by machine learning in which the state data detected by at least the sensor is used as a training data set and is a learned model related to the state data and a quality element of the molded item; and
a quality prediction unit configured to predict the quality element of the molded item which is newly molded based on the state data newly detected by the sensor and the learned model.

2. The quality prediction system for the molded item according to claim 1,
wherein the sensor includes a first pressure sensor detecting a pressure received from the molten material supplied in the cavity,
wherein the learned-model storage unit stores a model which is a learned model generated by machine learning in which pressure data detected by at least the first pressure sensor is used as a training data set and is a learned model related to the pressure data and the quality element of the molded item, and
wherein the quality prediction unit predicts the quality element of the molded item which is newly molded based on the pressure data newly detected by the first pressure sensor and the learned model.

3. The quality prediction system according to claim 2,
wherein in the molding method, a process of decreasing a predetermined pressure-keeping force is performed after a pressure-keeping process is performed with the pressure-keeping force for a predetermined time,
wherein the quality prediction system comprises a plurality of first pressure sensors configured to detect pressures received from the molten material at a plurality of different positions in the cavity,
wherein the learned-model storage unit stores a model which is a learned model generated by machine learning in which a plurality of the pieces of pressure data detected by the plurality of first pressure sensors in the process of decreasing the pressure-keeping force and a shape of the molded item are used as the training data set and is a learned model related to the plurality of pieces of pressure data detected by the plurality of first pressure sensors in the process of decreasing the pressure-keeping force and the shape of the molded item, and
wherein the quality prediction unit predicts shape prediction of the molded item which is newly molded based on the plurality of pieces of pressure data newly detected by the plurality of first pressure sensors in the process of decreasing the pressure-keeping force and the learned model.

4. The quality prediction system according to claim 3, wherein the plurality of first pressure sensors are disposed at a plurality of positions at which distances from the gate are different in an inflow path along which the molten material flows in the cavity from the gate of the mold.

5. The quality prediction system according to claim 4, wherein the plurality of first pressure sensors are disposed at least at two positions, a position near the gate in the inflow path and a position close to a position farthest from the gate in the inflow path.

6. The quality prediction system according to claim 4,
wherein the molded item and the cavity are annular,
wherein the mold has the gate at one position, and
wherein the inflow path is a path along which the molten material flows in a circumferential direction of the annular cavity from the gate.

7. The quality prediction system according to claim 6, wherein the quality prediction unit predicts roundness of an outer circumferential surface or an inner circumferential surface of the annular molded item as the quality element.

8. The quality prediction system according to claim 3, wherein the training data set includes a value indicating a variation in the pressure data between the first pressure sensors.

9. The quality prediction system according to claim 3, wherein when a relation between the pressure data and a time elapsed after a decrease in the pressure-keeping force starts is defined as decreasing process transition data, the training data set includes an integrated value obtained by integrating the decreasing process transition data with respect to time.

10. The quality prediction system according to claim 3, wherein when a relation between the pressure data and a time elapsed after a decrease in the pressure-keeping force starts is defined as decreasing process transition data, the training data set includes a derivative value obtained by differentiating the decreasing process transition data with respect to time.

11. The quality prediction system according to claim 3, wherein when a time necessary until the pressure data detected by the first pressure sensor becomes a predetermined value or less after the decrease in the pressure-keeping force starts is defined as a pressure-keeping decrease time, the pressure data set includes a difference in the pressure-keeping decrease time between the first pressure sensors.

12. The quality prediction system according to claim 2,
wherein in the molding method, a process of decreasing a predetermined pressure-keeping force is performed after a pressure-keeping process is performed with the pressure-keeping force for a predetermined time,
wherein the learned model storage unit stores a model which is a learned model generated by machine learning in which the pressure data detected by the first pressure sensor in the pressure-keeping process and mass of the molded item are used as the training data set and is a learned model related to the pressure data detected by the first pressure sensor in the pressure-keeping process and the mass of the molded item, and
wherein the quality prediction unit predicts mass of the molded item which is newly molded based on the pressure data newly detected by the first pressure sensor in the pressure-keeping process and the learned model.

13. The quality prediction system according to claim 12, wherein the first pressure sensor is disposed at a position closer to a farthest position from the gate than the gate in the inflow path along which the molten material flows in the cavity from the gate of the mold.

14. The quality prediction system according to claim 12, wherein when a relation between a time of the pressure-keeping process and the pressure data detected by the first pressure sensor is defined as pressure-keeping process transition data, the training data set includes an integrated value obtained by integrating the pressure-keeping process transition data with respect to time.

15. The quality prediction system according to claim 13, wherein the training data set includes at least one of a maximum value and a mean value of the pressure data detected by the first pressure sensors in the pressure-keeping process.

16. The quality prediction system according to claim 12, further comprising:
a second pressure sensor disposed in a runner of the mold,
wherein the learned-model storage unit stores the pressure data detected by the first pressure sensor in the pressure-keeping process, the pressure data detected by the second pressure sensor in the pressure-keeping process, and the learned model related to the mass of the molded item, and
wherein the quality prediction unit predicts mass of the molded item which is newly molded based on the pressure data newly detected by the first pressure sensor in the pressure-keeping process, the pressure data newly detected by the second pressure sensor in the pressure-keeping process, and the learned model.

17. The quality prediction system according to claim 2,
wherein in the molding method, a process of decreasing a predetermined pressure-keeping force is performed after a pressure-keeping process is performed with the pressure-keeping force for a predetermined time,
wherein the learned model storage unit stores a model which is a learned model generated by machine learning in which the pressure data detected by the first pressure sensor in the pressure-keeping process and a void volume of the molded item are used as the training data set and is a learned model related to the pressure data detected by the first pressure sensor in the pressure-keeping process and the void volume of the molded item, and
wherein the quality prediction unit predicts a void volume of the molded item which is newly molded based on the pressure data newly detected by the first pressure sensor in the pressure-keeping process and the learned model.

18. The quality prediction system according to claim 17, wherein the first pressure sensor is disposed at a position closer to a farthest position from the gate than the gate in the inflow path along which the molten material flows in the cavity from the gate of the mold.

19. The quality prediction system according to claim 17, wherein when a relation between a time of the pressure-keeping process and the pressure data detected by the first pressure sensor is defined as pressure-keeping process transition data, the training data set includes an integrated value obtained by integrating the pressure-keeping process transition data with respect to time.

20. The quality prediction system according to claim 18, wherein the training data set includes at least one of a maximum value and a mean value of the pressure data detected by the first pressure sensors in the pressure-keeping process.

21. The quality prediction system according to claim 17, further comprising:
a second pressure sensor disposed in a runner of the mold,
wherein the learned-model storage unit stores the pressure data detected by the first pressure sensor in the pressure-keeping process, the pressure data detected by the second pressure sensor in the pressure-keeping process, and the learned model related to the void volume of the molded item, and
wherein the quality prediction unit predicts a void volume of the molded item which is newly molded based on the pressure data newly detected by the first pressure sensor in the pressure-keeping process, the pressure data newly detected by the second pressure sensor in the pressure-keeping process, and the learned model.

22. The quality prediction system according to claim 17, further comprising:
a temperature sensor disposed in the mold and configured to detect a temperature of the molten material in the cavity,
wherein the learned-model storage unit stores the pressure data detected by the first pressure sensor in the pressure-keeping process, temperature data detected by the temperature sensor in the pressure-keeping process, and the learned model related to the void volume of the molded item, and
wherein the quality prediction unit predicts a void volume of the molded item which is newly molded based on the temperature data newly detected by the temperature sensor in the pressure-keeping process, the pressure data newly detected by the first pressure sensor in the pressure-keeping process, and the learned model.

23. The quality prediction system according to claim 17, wherein the quality prediction unit determines strength of the molded item based on a predicted value of the void volume.

24. The quality prediction system for the molded item according to claim 1,
wherein the sensor includes a material temperature sensor detecting a temperature of the molten material supplied in the cavity,
wherein the learned-model storage unit stores a model which is a learned model generated by machine learning in which material temperature data detected by at least the material temperature sensor is used as a training data set and is the learned model related to the material temperature data detected by the material temperature sensor and a quality element of the molded item, and
wherein the quality prediction unit predicts the quality element of the molded item which is newly molded based on the material temperature data newly detected by the material temperature sensor and the learned model.

25. The quality prediction system for the molded item according to claim 24,
wherein the learned-model storage unit stores the learned model indicating a relation between the quality element of the molded item and first temperature data which is a temperature of the molten material detected by the material temperature sensor when the mold is opened in a state in which the molten material is supplied to the cavity, and
wherein the quality prediction unit predicts the quality of the molded item based on the first temperature data and the learned model.

26. The quality prediction system for the molded item according to claim 25,
wherein the quality prediction system for the molded item further comprises an ambient temperature sensor configured to detect an ambient temperature at a position at which the mold is disposed,
wherein the learned-model storage unit stores the learned model indicating a relation among the first temperature data, the ambient temperature data detected by the ambient temperature sensor, and the quality element of the molded item, and
wherein the quality prediction unit predicts the quality element of the molded item based on the first temperature data, the ambient temperature data, and the learned model.

27. The quality prediction system for the molded item according to claim 25, wherein the quality element of the molded item is a dimension of the molded item.

28. The quality prediction system for the molded item according to claim 27,
wherein the molded item and the cavity are annular, and
wherein the quality element of the molded item is an outer diameter of the molded item.

29. The quality prediction system for the molded item according to claim 24,
wherein the learned-model storage unit stores the learned model indicating a relation between a quality element of the molded item and second temperature data which is a maximum temperature of the molten material detected by the material temperature sensor while the molten material is supplied to the cavity, and
wherein the quality prediction unit predicts the quality of the molded item based on the second temperature data and the learned model.

30. The quality prediction system for the molded item according to claim 29, wherein the quality element of the molded item is a dimension or a shape of the molded item.

31. The quality prediction system for the molded item according to claim 30,
wherein the molded item and the cavity are annular, and
wherein the quality element of the molded item is an outer diameter or roundness of the molded item.

32. The quality prediction system for the molded item according to claim 24, wherein the material temperature sensor is disposed at a position at which temperature of the molten material is highest in an inflow path along which the molten material flows in the cavity from the gate of the mold.

33. The quality prediction system for the molded item according to claim 28, wherein the material temperature sensor is disposed at least at a position closer to a farthest position from the gate than the gate in an inflow path along which the molten material flows in the cavity from the gate of the mold.

34. The quality prediction system according to claim 1, wherein the quality prediction unit performs quality determination on the molded item based on a predicted value and an allowable value of the quality element.

35. The quality prediction system according to claim 34, wherein the quality prediction unit performs quality determination on the molded item before a next step is performed after the molded item is molded.

36. The quality prediction system according to claim 34, wherein the quality prediction system performs a disposal process or a selection process for the molded item determined to be bad in the quality determination for the molded item.

37. The quality prediction system according to claim 1, further comprising:
a learned-model generation unit configured to generate the learned model by machine learning in which state data detected by at least the sensor is used as the training data set and store the generated learned model in the learned-model storage unit.

38. The quality prediction system according to claim 37, further comprising:
a server provided to be able to communicate with a plurality of the molding machines; and
a plurality of quality prediction devices provided to correspond to the plurality of molding machines,
wherein the server includes
a training data set acquisition unit acquiring the state data from the plurality of molding machines and acquiring the quality element of the molded items molded by the plurality of molding machines, and
the learned-model generation unit generating the learned model based on the state data acquired by the training data set acquisition unit and the quality element of the molded item, and
wherein the quality prediction device includes
a molding data acquisition unit acquiring at least the state data from the corresponding molding machine,
the learned-model storage unit, and
the quality prediction unit.

39. A quality prediction system for a molded item applied to a molding method of molding the molded item by supplying a molten material to a cavity of a mold of a molding machine, the quality prediction system comprising:
a sensor disposed in the mold and configured to detect state data regarding the molten material supplied in the cavity; and
a learned-model generation unit configured to generate a learned model related to state data detected by at least the sensor and a quality element of the molded item by machine learning in which the state data is used as a training data set.

40. A molding machine used for the quality prediction system according to claim 1, the molding machine comprising:
an operation instruction unit configured to give operation instruction data to a control device of the molding machine; and
an operation instruction data adjustment unit configured to adjust the operation instruction data based on a prediction result of the quality element by the quality prediction unit.
